(19) United States
(12) Patent Application Publication
(10) Pub. No.: US 2005/0254579 A1
(43) Pub. Date: Nov. 17, 2005

(54) Image data compression device, electronic apparatus and image data compression method

(76) Inventor: Yoshimasa Kondo, Matsumoto (JP)

Correspondence Address: HARNESS, DICKEY & PIERCE, P.L.C., P.O. BOX 828, BLOOMFIELD HILLS, MI, 48303, US

(21) Appl. No.: 11/126,999

(22) Filed: May 11, 2005

(30) Foreign Application Priority Data
May 17, 2004 (JP) 2004-146945

(51) Int. Cl. H04N 7/12

(52) U.S. Cl. 375/240.03; 375/240.21; 375/240.2

(57) ABSTRACT

An image data compression device includes a decimation detector, a compression processor and a frame skip unit. The decimation detector detects whether or not an input frame is a frame to be decimated every time image data of one frame is input from an imaging unit. The compression processor compresses the image data. The frame skip unit implements skip processing for skipping the compression of image data of one frame by the compression processor based on the detection result by the decimation detector. The frame skip unit implements the skip processing on condition that the decimation detector has determined that the input frame is a frame to be decimated.

### RELATED APPLICATIONS

This application claims priority to Japanese Patent Application No. 2004-146945 filed May 17, 2004 which is hereby expressly incorporated by reference herein in its entirety.

### BACKGROUND

1. Technical Field

The present invention relates to an image data compression device, an electronic apparatus and an image data compression method.

2. Related Art

Moving picture experts group phase 4 (MPEG-4) has been standardized as a universal encoding method for multimedia information such as image data of still or moving images, and audio data. Recent portable apparatuses allow the encoding and decoding of image data compliant with the MPEG-4 standard and thus can play moving images and send/receive data via a network.

In the MPEG-4 standard, compressed data obtained by encoding image data of moving images need be created at a certain rate. However, in the case of compressing image data of moving images, the compression efficiency significantly varies depending on kinds of image data. MPEG-4 Visual Part (Recommendation report ISO/IEC 14496-2:1999(E) Annex L) has discloses a rate control method in which in order to keep this variation within a certain range, the amount of generated codes is controlled for creating compressed data at a certain rate.

When implementing encoding (compression) compliant with MPEG-4, a sequence of processing could all be carried out by hardware. In this case, however, circuit scale becomes larger and therefore the miniaturization of integrated circuits (IC, semiconductor device) will become difficult. Particularly for portable apparatuses such as cellular phones, demands to miniaturize apparatuses are not met.

In contrast, a sequence of encoding processing could all be implemented by using software. In this case, however, the load of a central processing unit (CPU) operating software is increased. Therefore, the time for other processing by the CPU is restricted, which lowers the performance of the apparatus incorporating the CPU. In addition, the processing time of the CPU is increased, increasing power consumption. Particularly for portable apparatuses such as cellular phones, demands to achieve lower power consumption for reducing the draining of a battery are not met.

Therefore, a sequence of encoding processing may be shared by hardware and software. However, the studies by the present inventors have revealed that when optimizing the sharing of a sequence of encoding processing by hardware and software, the rate control method disclosed in MPEG-4 Visual Part (Recommendation report ISO/IEC 14496-2:1999(E) Annex L) can not be implemented. Specifically, in the case of dividing processing into processing by hardware and processing by software of which processing speeds are different, a buffer for eliminating the processing speed difference is necessary. However, it has been revealed that if the buffer is provided, the above-described rate control method can not be implemented and therefore the optimization of sharing of image data compression processing by hardware and software problematically becomes incompatible with the generation of compressed data at a certain rate.

Meanwhile, MPEG-4 encoding is implemented for each frame and image data to be processed is supplied from a camera module (imaging unit), for example. That is, a camera module supplies image data that has been captured by imaging to an image data compression device in each frame.

In the above-described rate control method, the data size of encoded data is controlled by varying the data size of encoded data for each frame. Therefore, in an image data compression device employing the above-described rate control method, it is necessary that the input frame rate of image data from a camera module correspond with the generation rate of encoded data.

In recent years, however, as the performance of imaging elements such as camera modules becomes larger, the image size of one-frame image becomes greatly larger and a frame rate becomes greatly higher, which allows the smooth representation of moving images. If an input frame rate becomes higher particularly, a problem also has come to be caused that the input frame rate of image data from a camera module can not be matched with the generation rate of encoded data and therefore the above-described rate control method can not be realized.

The present invention is made in consideration of the above technical problems, and an advantage of the present invention is to provide an image data compression device, an electronic apparatus and an image data compression method that optimize the sharing of image data compression processing by hardware and software, and generate compressed data at a certain rate while addressing an increase of the input frame rate of image data.

### SUMMARY

In order to solve the above-described problem, an aspect of the present invention relates to an image data compression device for compressing image data. The device comprises: a decimation detector detecting whether or not an input frame is a frame to be decimated every time image data of one frame is input from an imaging unit; a compression processor compressing the image data to generate encoded data at a certain rate; and a frame skip unit implementing skip processing for skipping compression processing for image data of one frame by the compression processor, based on a detection result by the decimation detector, wherein the frame skip unit implements the skip processing on condition that the decimation detector has determined that the input frame is a frame to be decimated.

In the aspect of the present invention, the image data compression device implements compression processing for each frame for image data input from the imaging unit in each frame so as to generate encoded data at a certain rate. In addition, prior to the compression processing, a determination is made as to whether or not the input frame from the imaging unit is a frame to be decimated. If the frame is determined as a frame to be decimated, compression processing for image data of the input frame is skipped.

This feature can provide an image data compression device that implements compression processing for image data from the imaging unit even if the input frame rate of image data from the imaging unit is higher than the generation rate of encoded data.

In addition, according to the aspect of the present invention, the supply of image data can be skipped by one frame even if the image data compression device implements various controls for each frame in order to generate encoded data at a certain rate. Therefore, the aspect of the present invention can easily be applied to an image data compression device carrying out existing rate control without complicating controls.

In the image data compression device according to another aspect of the present invention, the decimation detector may detect, of CA input frames of image data from the imaging unit, (CA-TA) frames of image data as a frame to be decimated, where CA is an input frame rate of image data from the imaging unit (CA is a positive integer) and TA is a generation rate of encoded data after the compression processing (CA>TA, TA is a positive integer).

In the image data compression device according to another aspect of the present invention, the decimation detector may compare a count value of a frame of image data input from the imaging unit with one value of at least one frame decimation interval that is decimal data determined as an integer multiple of CA/(CA-TA). Furthermore, the decimation detector may detect the input frame as a frame to be decimated if the count value is equal to or more than the one value of the at least one frame decimation interval.

The aspect of the present invention can determine whether or not a frame is a frame to be decimated with simple processing. Thus, controls and configuration can be simplified while implementation into an image data compression device can be achieved at low costs.

In the image data compression device according to another aspect of the present invention, the frame decimation interval is determined prior to processing of the decimation detector on condition that an input frame rate of image data from the imaging unit has varied.

According to the aspect of the present invention, even when a plurality of frame decimation intervals (cumulative values) is determined, the necessity to determine the values for each frame is eliminated. In addition, the compression device can address the case in which the input frame rate of an imaging unit is variable.

In the image data compression device according to another aspect of the present invention, the compression processor may include a rate controller that varies data size after the compression processing for each frame to control a generation rate of data after the compression processing

In the image data compression device according to another aspect of the present invention, the compression processor may include: a quantizer that quantizes the image data with a quantization step varying based on a quantization parameter; a FIFO buffer in which quantized data of a plurality of frames quantized by the quantizer is buffered; and an encoded data generator that reads out quantized data from the FIFO buffer asynchronously with writing to the FIFO buffer so as to generate encoded data by encoding the quantized data. In addition, the rate controller may determine, from data size of quantized data of a previous frame of a current frame, predicted data size of encoded data of the previous frame so as to determine the quantization parameter by using the predicted data size. The rate controller may vary a quantization step of the quantizer for each frame based on the quantization parameter so as to control data size of encoded data. Furthermore, the frame skip unit may implement the skip processing if frames having the quantization parameter larger than a skip threshold consecutively appear the number of times set as a consecutive skips threshold or more times.

In the aspect of the present invention, the FIFO buffer is provided between the quantizer and encoded data generator included in the compression processor. Thus, the processing at the quantizer and encoded data generator can be implemented asynchronously and in parallel. Also, when controlling the rate of generating encoded data by the encoded data generator, the rate controller determines, from the data size of quantized data written to the FIFO buffer, the predicted data size of encoded data generated by the encoded data generator, and then varies the quantization step of the quantizer based on the predicted data size.

Since the processing at the quantizer and encoded data generator can be implemented asynchronously, the generation rate of encoded data can be controlled and thus encoded data obtained by compressing image data can be generated at a certain rate even if the rate control method disclosed in MPEG-4 Visual Part (Recommendation report ISO/IEC 14496-2:1999(E) Annex L) is unavailable. Moreover, the rate control can be carried out accurately.

Furthermore, the frame skip unit implements skip processing if frames having the quantization parameter larger than the skip threshold consecutively appear the number of times set as the consecutive skips threshold or more times. Therefore, even when the above-described rate control is carried out, the increase of encoded data generated for each frame is suppressed when the increase of size of encoded data precludes the sure maintenance of the bit rate depending on images (particularly images that are not a natural image), thereby allowing the maintenance of the bit rate.

In the image data compression device according to another aspect of the present invention, the compression processor may include: a quantizer that quantizes the image data with a quantization step varying based on a quantization parameter; a FIFO buffer in which quantized data of a plurality of frames quantized by the quantizer is buffered; and an encoded data generator that reads out quantized data from the FIFO buffer asynchronously with writing to the FIFO buffer so as to generate encoded data by encoding the quantized data. In addition, the rate controller may determine, from data size of quantized data of a previous frame of a current frame, predicted data size of encoded data of the previous frame so as to determine the quantization parameter by using the predicted data size. The rate controller may vary a quantization step of the quantizer for each frame based on the quantization parameter so as to control data size of encoded data. Furthermore, the frame skip unit may implement the skip processing if a complexity corresponding to a difference between image data to be quantized by the quantizer and image data of a previous frame of a frame of the image data to be quantized is equal to or more than a complexity threshold.

In the aspect of the present invention, the FIFO buffer is provided between the quantizer and encoded data generator included in the compression processor. Thus, the processing at the quantizer and encoded data generator can be implemented asynchronously and in parallel. Also, when controlling the rate of generating encoded data by the encoded data generator, the rate controller determines, from the data size of quantized data written to the FIFO buffer, the predicted data size of encoded data generated by the encoded data generator, and then varies the quantization step of the quantizer based on the predicted data size.

Since the processing at the quantizer and encoded data generator can be implemented asynchronously, the generation rate of encoded data can be controlled and thus encoded data obtained by compressing image data can be generated at a certain rate even if the rate control method disclosed in MPEG-4 Visual Part (Recommendation report ISO/IEC 14496-2:1999(E) Annex L) is unavailable. Moreover, the rate control can be carried out accurately.

The frame skip unit implements skip processing if the complexity, which is determined at the time of motion estimation and used when calculating a quantization parameter, is equal to or more than the complexity threshold. Therefore, even when the above-described rate control is carried out, the increase of encoded data generated for each frame is suppressed when the increase of size of encoded data precludes the sure maintenance of the bit rate depending on images (particularly images that are not a natural image), thereby allowing the maintenance of the bit rate.

In the image data compression device according to another aspect of the present invention, the rate controller may determine, by using the predicted data size, a quantization parameter that is equal to or less than a settable quantization parameter upper threshold.

According to the aspect of the present invention, since the quantization parameter is determined so as to be equal to or less than quantization parameter upper threshold, the size of encoded data can be decreased by decreasing the size of quantized data without deteriorating image quality. In addition, a certain bit rate can be maintained since the skip processing can be carried out as described above.

In the image data compression device according to another aspect of the present invention, the rate controller may determine, by using the predicted data size, the quantization parameter that is equal to or less than the quantization parameter upper threshold and is equal to or more than a settable quantization parameter lower threshold.

In the aspect of the present invention, the rate controller determines the quantization parameter that is equal to or less than the quantization parameter upper threshold. In general, the larger quantization parameter leads to the greater decimation of image data, and therefore allows the smaller size of quantized data and encoded data. However, the image obtained by decoding the encoded data has not a few block noises. Therefore, the aspect of the present invention can avoid block noises in images obtained by decoding compressed data after encoded even if rate control is carried out as described above.

Also, the rate controller determines the quantization parameter that is equal to or more than the quantization parameter lower threshold. In general, the smaller quantization parameter leads to the less decimation of image data, increasing the size of quantized data. However, the image obtained by decoding the encoded data has less block noises. Thus, the aspect of the present invention can avoid unnecessarily large data size even if rate control is carried out as described above.

Therefore, the aspect of the present invention can easily achieve rate control for optimizing the compression efficiency and image quality.

The image data compression device according to another aspect of the present invention may further comprise a count register holding count data corresponding to the number of accesses to the FIFO buffer. The rate controller may determine the predicted data size from the count data.

The aspect of the present invention can obtainen information equivalent to the data size of quantized data with a simple configuration, aud thus can provide an image data compression device allowing the rate control method descrided in MPEG-4 Visual Part (Recommendation report ISO/IEC 14496-2:1999(E) Annex L) with a simpler configuration.

In the image data compression device according to another aspect of the present invention, the predicted data size may be determined by linearly transforming data size of quantized data of the previous frame.

In the image data compression device according to another aspect of the present invention, a coefficient corresponding to an encoding efficiency of the encoded data generator may be used for the linear transformation.

In the image data compression device according to another aspect of the present invention, correction for header size added to the encoded data may be achieved by the linear transformation.

In the aspect of the present invention, with focusing attention on the almost linear relationship between the data size of quantized data and the data size of encoded data, predicted data size is determined with a linear transformation formula representing the linear relationship. This allows accurate rate control without increasing the processing load.

The image data compression device according to another aspect of the present invention may further comprise a quantization table storing a quantization step value. The rate controller may vary the quantization step by implementing quantization with using a product of the quantization parameter and the quantization step value.

The image data compression device according to another aspect of the present invention may further comprise a discrete cosine transform unit supplying the image data that has been discrete cosine transformed to the quantizer in each frame.

In the image data compression device according to another aspect of the present invention may further comprise: a hardware processor that processes image data of moving images by hardware; and a software processor that encodes quantized data read out from the FIFO buffer by software to generate encoded data. The hardware processor may include the quantizer and the FIFO buffer. The software processor may include the encoded data generator, the rate controller, the decimation detector and the frame skip unit.

In many cases, quantized moving image data has the greatly large amount of zero data and therefore includes greatly less kinds of information amounts of data compared with data before quantization. In addition, the load of calculation itself for encoding is typically small. Therefore, even if a software processor handles the processing, the processing load is small since the processing involves a less information amount and light calculation load. In contrast, much of quantization processing involves a large information amount and complicated calculation, and therefore causes too heavy a load for software processing. Although the quantization processing involves a heavy load, the necessity for modification is small if the processing is standardized. In addition, the quantization processing includes much repeat processing. Therefore, the quantization processing is suitable for a hardware processor. Also, since the amount of data after being processed at a hardware processor is small, the amount of data transmitted from the hardware processor to a software processor is small, leading to a light transmission load. In addition, since the FIFO buffer intervenes between the software processor and hardware processor, software processing and hardware processing can be carried out in parallel. Moreover, the dividing into software processing and hardware processing allows both the miniaturization of a device and reduction of power consumption.

In the image data compression device according to another aspect of the present invention, the hardware processor may output, as motion vector information, a difference between input image data of a current frame and past image data of a previous frame of the current frame. The hardware processor may implement discrete cosine transform for the motion vector information and output transformed information as the image data to the quantizer. In addition, the hardware processor may generate the past image data based on inverse quantized data determined by inverse quantizing the quantized data with the quantization step.

In the image data compression device according to another aspect of the present invention, the software compressor may encode quantized data read out from the FIFO buffer into a variable length code.

In the image data compression device according to another aspect of the present invention, the software processor may implement scan processing for rearranging quantized data read out from the FIFO buffer and encodes a result of the scan processing into a variable length code.

In the image data compression device according to another aspect of the present invention, the software processor may determine a DC component and an AC component from quantized data read out from the FIFO buffer and implement scan processing for rearranging the DC component and the AC component so as to encode a result of the scan processing into a variable length code.

Another aspect of the present invention relates to an electronic apparatus comprising any of the above-described image data compression devices.

The aspect of the present invention can provide an electronic apparatus that optimizes the sharing of compression processing of image data by hardware and software, and generates compressed data at a certain rate with addressing even the increase of the input frame rate of image data.

Another aspect of the present invention relates to an image data compression method for compressing image data. The method comprises: detecting whether or not an input frame is a frame to be decimated every time image data of one frame is input from an imaging unit; compressing image data of a frame that has been determined as a frame not to be decimated to generate encoded data at a certain rate; and detecting, of CA input frames of image data from the imaging unit, (CA-TA) frames of image data as a frame to be decimated, where CA is an input frame rate of image data from the imaging unit (CA is a positive integer), and TA is a generation rate of encoded data after the compression processing (CA>TA, TA is a positive integer).

In the image data compression method according to another aspect of the present invention, data size after the compression processing may be varied for each frame to control a generation rate of data after the compression processing.

In the image data compression method according to another aspect of the present invention, a count value of a frame of image data input from the imaging unit may be compared with one value of at least one frame decimation interval that is decimal data determined as an integer multiple of CA/(CA-TA). The input frame may be detected as a frame to be decimated if the count value is equal to or more than the one value of the at least one frame decimation interval.

### BRIEF DESCRIPTION OF THE DRAWINGS

FIGS. 1A and 1B are explanatory diagrams showing encoding and decoding of MPEG-4, respectively.

FIG. 2 is an explanatory diagram of a macroblock.

FIG. 3 is an explanatory diagram of one example of DCT coefficients.

FIG. 4 is an explanatory diagram of one example of a quantization table.

FIG. 5 is an explanatory diagram of one example of quantized DCT coefficients.

FIG. 6 is an explanatory diagram of a model formula used in a rate control method.

FIG. 7 is a flow diagram of one example of rate control processing using the model formula shown in FIG. 6.

FIG. 8 is a block diagram schematically showing a configuration of an image data compression device of an embodiment.

FIG. 9 is a block diagram showing a configuration example of an imaging unit in FIG. 8.

FIG. 10 is an explanatory diagram of a method of processing by a decimation detector in FIG. 8.

FIG. 11 is an explanatory diagram of an example of processing by the decimation detector in FIG. 8.

FIG. 12 is an explanatory diagram of predicted data size.

FIG. 13 is an explanatory diagram of a method of rate control in the embodiment.

FIG. 14 is a diagram schematically showing the operation timing in the rate control method shown in FIG. 13.

FIG. 15 is a diagram schematically showing the relationship among a quantization parameter, the data size of encoded data and block noises.

FIG. 16 is a flow diagram of the first half of one example of calculation processing of a quantization parameter.

FIG. 17 is a flow diagram of the last half of one example of calculation processing of a quantization parameter.

FIG. 18 is an explanatory diagram of variables used in calculation processing of a quantization parameter.

FIG. 19 is a flow diagram of one example of calculation processing for the number of bits used for encoding.

FIG. 20 is a flow diagram of one example of adjustment processing of a quantization parameter.

FIG. 21 is an explanatory diagram of quantization processing in the embodiment.

FIG. 22 is a flow diagram of one example of skip processing in the embodiment.

FIG. 23 is a flow diagram of another example of skip processing in the embodiment.

FIG. 24 is a flow diagram of yet another example of skip processing in the embodiment.

FIG. 25 is a detailed functional block diagram of the image data compression device of the embodiment.

FIG. 26 is a diagram showing a hardware configuration example of the image data compression device in FIG. 25.

FIG. 27 is a diagram showing a hardware configuration example of a motion estimator in FIG. 26.

FIG. 28 is a flow diagram of one example of interrupt reception processing implemented in a host.

FIG. 29 is a flow diagram of one example of camera VSYNC interrupt processing.

FIG. 30 is a flow diagram of one example of processing for determining the cumulative values of a frame decimation interval.

FIG. 31 is a flow diagram of one example of ME interrupt processing.

FIG. 32 is a flow diagram of one example of encoding completion interrupt processing.

FIG. 33 is a diagram showing the relationship between count data and predicted data size in the embodiment.

FIG. 34 is a diagram showing the changes of free space on a VBV buffer in the embodiment.

FIG. 35 is a block diagram of a configuration example of a display controller in the embodiment.

FIG. 36 is a block diagram of a configuration example of an electronic apparatus to which the display controller in FIG. 35 is applied.

### DETAILED DESCRIPTION

An embodiment according to the present invention will be described below with reference to the drawings. The embodiment described below is not intended to unreasonably limit the present invention set forth in the claims. Also, the present invention may be practiced without some of the specific elements described below.

1. MPEG-4

First, a simple explanation will be made about MPEG-4 encoding. Decoding for expanding compressed data that has been encoded by the encoding will also be described.

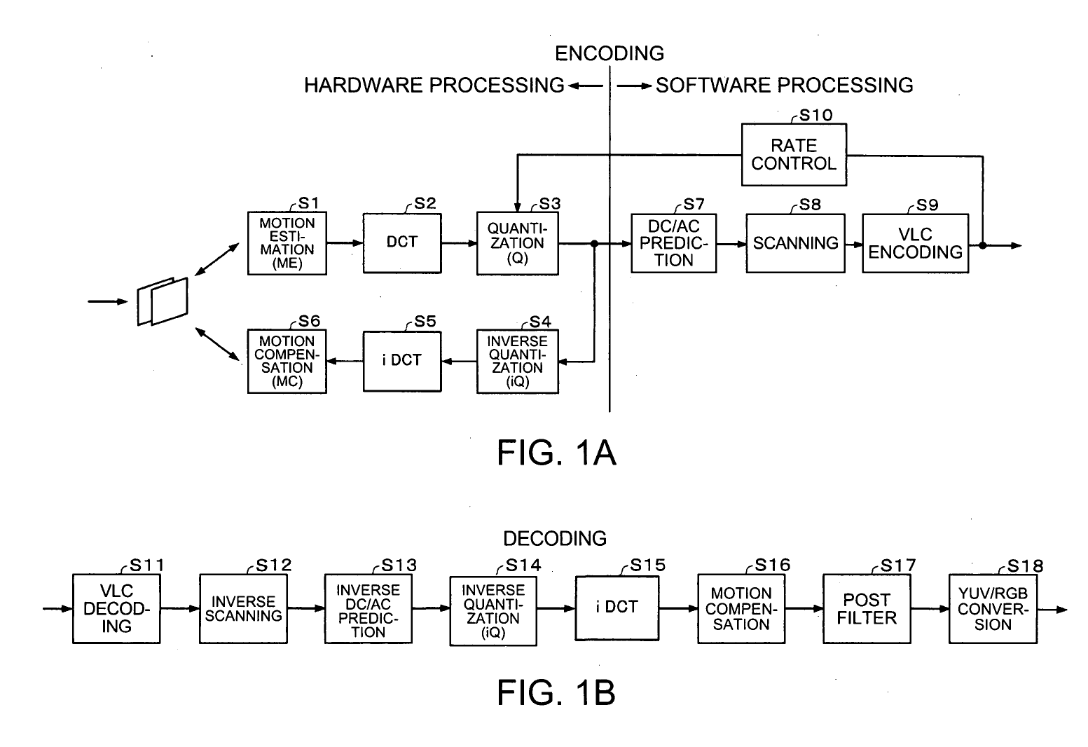

FIGS. 1A and 1B are explanatory diagrams showing encoding and decoding compliant with MPEG-4, respectively. Since the processing is explained in detail in, for example, “JPEG & MPEG Zsukai de wakaru gazou assyuku gijutsu” (co-authored by Hiroshi Ochi and Hideo Kuroda, published by NIPPON JITSUGYO PUBLISHING CO., LTD.), only processing related to the present invention will mainly be described.

In the encoding shown in FIG. 1A, first, motion estimation (ME) between two (two frame) consecutive images is performed (step S1). Specifically, the differences between the two images as to the respective same pixels are determined. The difference is zero in a pixel region having no variation between two images, resulting in a less information amount. In addition to zero data of the image region, the differences (positive and negative components) in a pixel region having variations between two images are used as information after motion estimation.

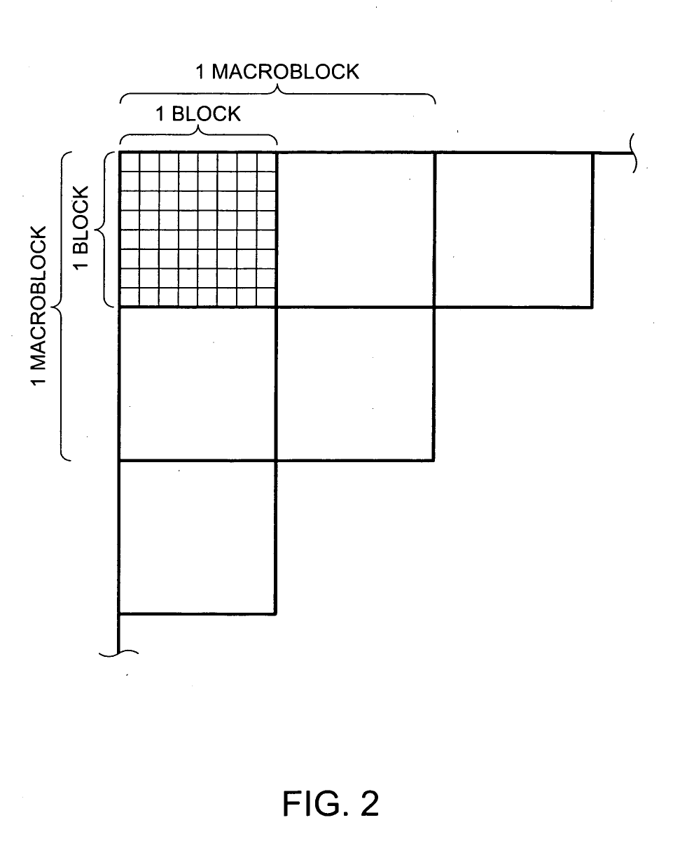

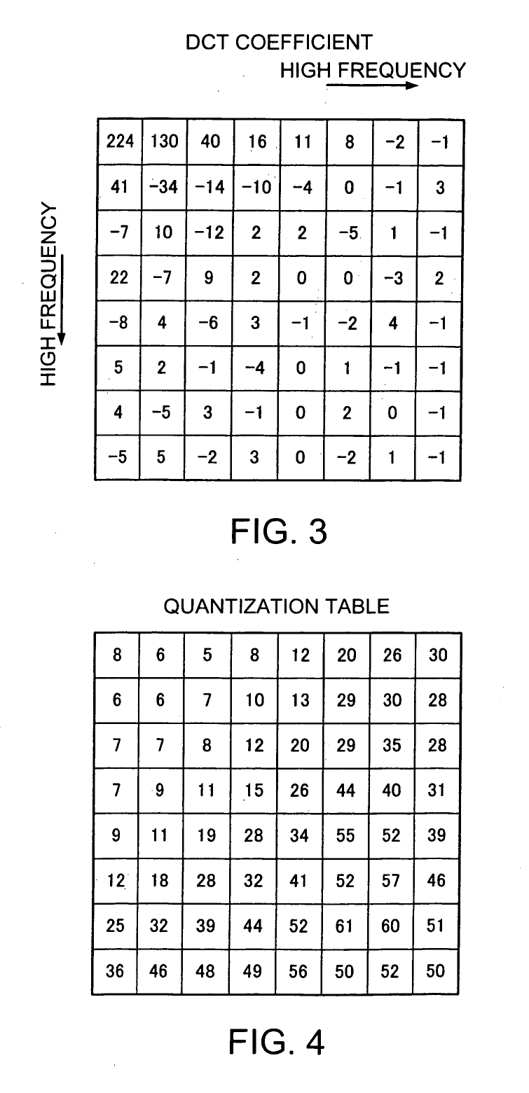

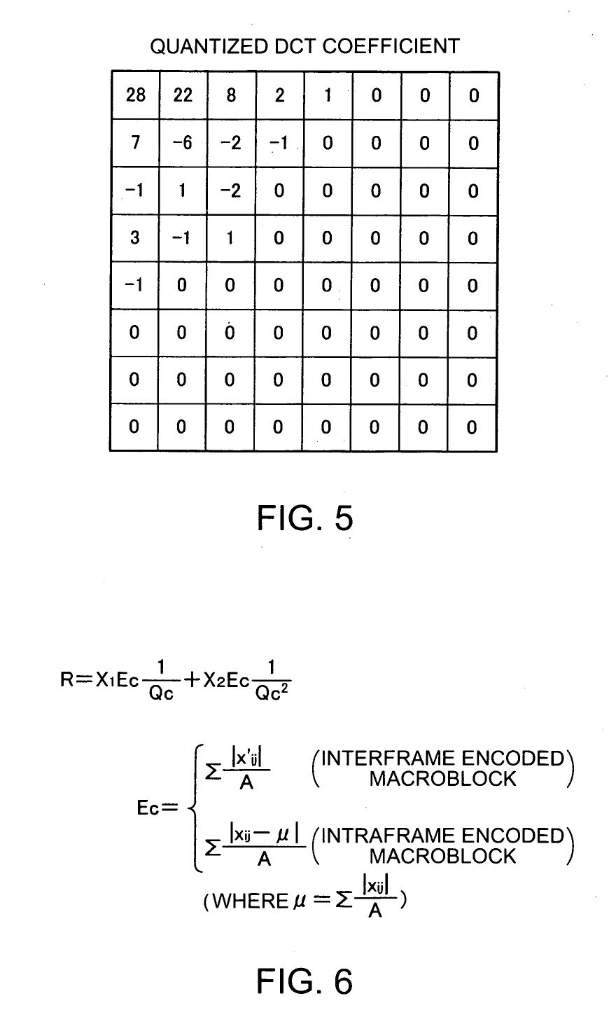

Subsequently, discrete cosine transform (DCT) is performed (step S2). The DCT is calculated by a unit of one block of eight pixels by eight pixels shown in FIG. 2 for determining DCT coefficients for each block. The DCT coefficients after DCT represent the gray-scale variation of an image in one block with the total brightness (DC component) and spatial frequencies (AC component). FIG. 3 illustrates one example of DCT coefficients in one block of eight pixels by eight pixels (quoted from the above-described book, p. 116, FIG. 5-6). The DCT coefficient at the left-upper corner shows a DC component, and other DCT coefficients show AC components. The omission of high frequency components of the AC components has little influence on image recognition.

Next, the DCT coefficients are quantized (step S3). The quantization is implemented for reducing an information amount by dividing each DCT coefficient in one block by a quantization step value at a corresponding position in a quantization table. For example, FIG. 5 illustrates DCT coefficients in one block obtained by quantizing the DCT coefficients of FIG. 3 by using the quantization table of FIG. 4 (quoted from the above-described book, p. 117, FIGS. 5-9 and 5-10). When the DCT coefficients of high frequency components are divided by quantization step values and the divided values are rounded off (counting fraction over 0.5 as one and disregarding the rest) to the whole number, particularly, almost all the resulting values become zero data and thus the information amount is significantly reduced.

For the encoding, a feedback route is needed in order to implement the above-described ME between the current frame and the next frame. In the feedback route, as shown in FIG. 1A, inverse quantization (iQ), inverse DCT and motion compensation (MC) are implemented (steps S4 to S6). The detailed description of MC operation is omitted. This processing is implemented by a unit of one macroblock of sixteen pixels by sixteen pixels shown in FIG. 2.

In the present embodiment, the processing of the steps S1 to S6 is performed by hardware.

Both DC/AC (direct current/alternate current component) prediction processing in a step S7 and scan processing in a step S8 of FIG. 1A are necessary for improving the efficiency of encoding into variable length codes (VLC) in a step S9. This is because for the encoding into VLCs in the step S9, the differences of DC components between the neighboring blocks need be encoded while the order of encoding AC components need be determined by scanning the block from lower frequencies to higher frequencies (it is also referred to as zigzag scanning).

The encoding into VLCs in the step S9 is also referred to as entropy encoding, of which encoding principle is that the code having a high frequency of appearance is represented with a small number of codes. Huffman encoding is used for the entropy encoding.

Then, with utilizing the result in the steps S7 and S8, the differences of DC components between the neighboring blocks are encoded while DCT coefficients of AC components are sequentially encoded from lower frequencies to higher frequencies in the order of the scanning.

The amount of generated information of image data varies depending on the complexity of the image and the motion intensity. The control of a generated code amount is required to eliminate this variation and send data at a certain transmitting rate. Rate control in a step S10 corresponds to this control. Typically a buffer memory is provided for rate control. The buffer memory monitors stored information amount so that information does not overflow from the buffer memory, and thus reduces the amount of generated information. Specifically, the quantization characteristic in the step S3 is coarsened to reduce the number of bits representing DCT coefficient values.

In the present embodiment, the processing of the steps S7 to S10 is performed by software. That is, the processing in the steps S7 to S10 is realized by hardware reading software therein.

FIG. 1B illustrates the decoding of image data that has been compressed through the encoding in FIG. 1A. The decoding is achieved by implementing inverse processing of the encoding of FIG. 1A in the reverse order. The term “post filter” in FIG. 1B is a filter for eliminating block noises. Also, the term “YUV/RGB conversion” in FIG. 1B means that outputs from the post filter are converted from a YUV format to an RGB format.

2. Rate Control

Next, a simple explanation will be made about a method disclosed in MPEG-4 Visual Part (Recommendation report ISO/IEC 14496-2:1999(E) Annex L) concerning the rate control implemented in the step S10 shown in FIG. 1A. In this method, a quantization parameter used in encoding is changed. By changing a quantization parameter, the quantization step in the quantization (step S3) shown in FIG. 1A is changed to vary the quantization characteristic, and thereby controlling the amount of generated codes (size of data).

In this method, a quantization parameter Qc is set for each frame to control a generated code amount R at the time of encoding one frame. In this setting, the quantization parameter Qc is determined in accordance with a model formula shown in FIG. 6.

Referring to FIG. 6, R denotes the amount of generated codes at the time of encoding one frame, Qc denotes a quantization parameter, Ec denotes the complexity of a frame, and X₁ and X₂ denote parameters in the present model. For the complexity Ec of a frame, the average of absolute values as to pixels to be encoded is used. For an interframe encoded macroblock, the complexity Ec of a frame can be determined after ME as a value obtained by dividing, by an area A, the total sum of absolute values of difference values x′ᵢⱼ between the current frame and the previous frame. As for an intraframe encoded macroblock, the complexity Ec can be determined as a value obtained by dividing, by an area A, the total sum of absolute values of the difference values (|xᵢⱼ−μ|) between the current frame and a reference value μ. The reference value μ can be the average value as to all pixels in a macroblock.

As described above, referring to FIG. 6, the generated code amount is modeled as a quadratic with respect to the reciprocal number of a quantization parameter, including the complexity of a frame.

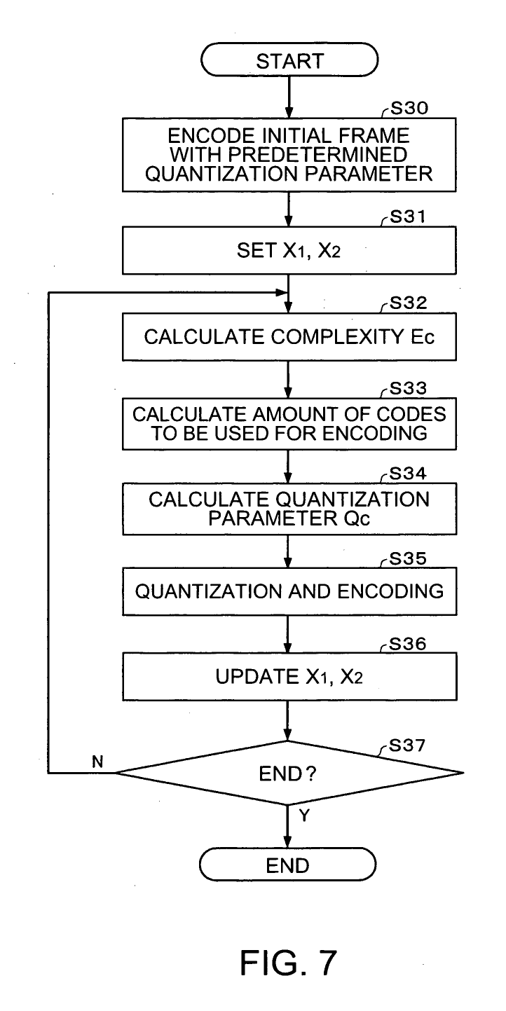

FIG. 7 shows one example of processing flow chart for rate control using the model formula shown in FIG. 6.

First, an initial frame is encoded by using a certain quantization parameter (step S30). Then, the initial values of the model parameters X₁ and X₂ are set (step S31). Subsequently, the complexity Ec of the current frame is calculated (step S32). The complexity Ec can be determined by using the formula shown in FIG. 6. Then, the amount of codes to be used for encoding is determined based on the amount of usable remaining codes and the amount of codes used for the previous frame (step S33).

Furthermore, the model parameters X₁ and X₂ set in the step S31 and the complexity Ec determined in the step S32 are set in the model formula of FIG. 6. Also, a value is set in the model formula of FIG. 6 as the generated code amount R at the time of encoding one frame. The value is obtained by subtracting the number of bits other than information of the header, motion vector and the like, of the number of bits used for the previous frame, from the amount of codes to be used for encoding determined in the step S33. Then, the quantization parameter Qc is determined by solving the quadratic of FIG. 6 including Qc as a parameter.

Subsequently, a frame is quantized and encoded by using the quantization parameter Qc determined in the step S34 (step S35). Then, the model parameters X₁ and X₂ are determined and updated from the model formula shown in FIG. 6 based on the quantization parameter, generated code amount and so on of the previous encoded frame (step S36).

When the processing sequence is ended under certain conditions (step S37: Y), the sequence of processing is finished (end). When the sequence is not ended (step S37: N), the sequence returns to the step S32. The above-described processing is implemented for each frame.

As described above, in the rate control method disclosed in MPEG-4 Visual Part (Recommendation report ISO/IEC 14496-2:1999(E) Annex L), it is necessary to reflect the result of encoding of the previous frame in the encoding of the next frame.

3. Image Data Compression Device

The present embodiment is to provide an image data compression device that makes hardware and software share the above-described encoding sequence, and optimizes the sharing.

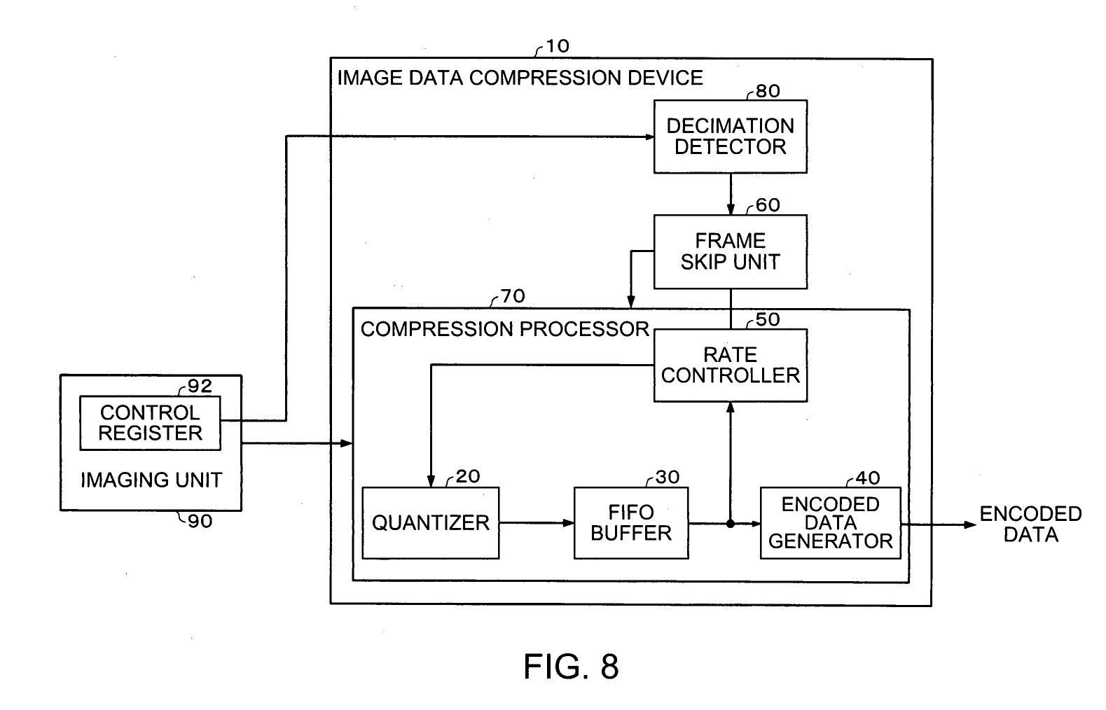

FIG. 8 is a block diagram schematically showing the configuration of an image data compression device according to the present embodiment.

An image data compression device 10 in the present embodiment carries out compression processing for image data from an imaging unit 90. The imaging unit 90 outputs image data captured through imaging to the image data compression device 10 in each frame (one screen). Examples of the imaging unit 90 include a camera module incorporating a charge-coupled device (CCD) camera (image sensor) or a complementary metal oxide semiconductor (CMOS) camera (image sensor).

The image data compression device 10 includes a compression processor 70. The compression processor 70 compresses image data from the imaging unit 90. In the present embodiment, the compression processing is compliant with the MPEG-4 standard, and encoded data as compressed data is output at a certain rate (for example, 15 frames per second).

Thus, the compression processor 70 includes a quantizer 20, a FIFO buffer 30 and an encoded data generator 40 so as to implement processing for compressing image data input in each frame.

The quantizer 20 implements the processing in the step S3 shown in FIG. 1A. The quantizer 20 quantizes image data for each frame with a quantization step varying based on a quantization parameter. In the quantizer 20, quantization parameter is set for each frame. The image data can be represented with DCT coefficients after DCT in the step S2 shown in FIG. 1A. In this case, DCT coefficients like those in FIG. 3 are divided by the product of a quantization parameter and quantization step values in a quantization table like that in FIG. 4, so as to be quantized as shown in FIG. 5.

Quantized data of plural frames, quantized by the quantizer 20, is buffered in the FIFO buffer 30. The quantization data output in each frame from the quantizer 20 is sequentially written to the FIFO buffer 30. The FIFO buffer 30 serves as a first-in first-out memory circuit.

The encoded data generator 40 reads out quantized data of one frame from the FIFO buffer 30 so as to generate encoded data obtained by encoding the quantized data. The reading out of quantized data of one frame from the FIFO buffer 30 by the encoded data generator 40 is asynchronous with the writing to the FIFO buffer 30.

By providing the FIFO buffer 30 between the quantizer 20 and the encoded data generator 40 as described above, the heavy load processing at the quantizer 20 can be assigned to hardware and the light load encoding processing at the encoded data generator 40 can be realized by software processing, while both the processing can be implemented in parallel.

The present invention is not limited to the following description in which the quantizer 20 is operated by high speed hardware, for example, and the encoded data generator 40 is operated by low speed software, for example. The present embodiment is also applicable to the case in which the encoded data generator 40 reads out quantized data from the FIFO buffer 30 asynchronously with the writing to the FIFO buffer 30. Therefore, the quantizer 20 may be operated by high speed hardware, for example, while the encoded data generator 40 may be operated by low speed hardware, for example. Otherwise, the quantizer 20 and the encoded data generator 40 may be operated by hardware reading in software, asynchronously with each other.

The image data compression device 10 includes a decimation detector 80. The decimation detector 80 detects whether or not an input frame is a frame to be decimated every time image data of one frame is input from the imaging unit 90. The determination by the decimation detector 80 as to whether or not an input frame is a frame to be decimated is made based on the input frame rate of image data from the imaging unit 90 and the generation rate of encoded data.

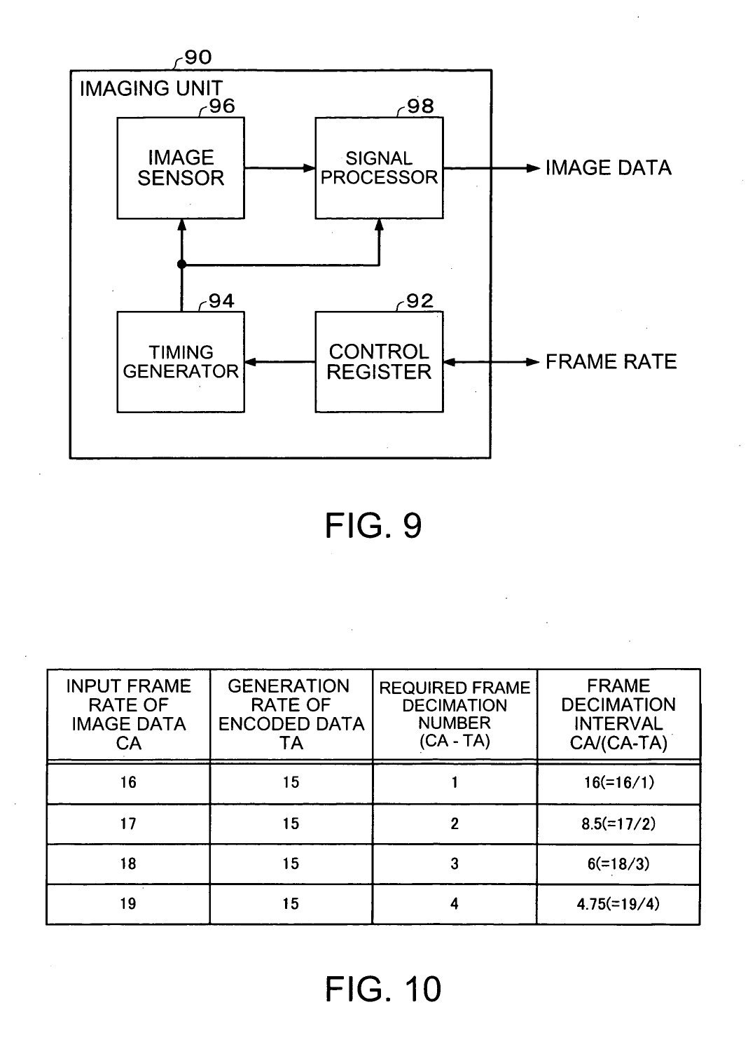

FIG. 9 is a block diagram showing a configuration example of the imaging unit 90.

The imaging unit 90 includes a control register 92, a timing generator 94, an image sensor 96 and a signal processor 98. The timing generator 94 generates a control signal at timing corresponding to the set value of the control register 92. In the present embodiment, data of captured images is output at a frame rate corresponding to the set value of the control register 92.

The image sensor 96 includes, for example, imaging elements provided for each pixel, and captures images by imaging in sync with control signals generated from the timing generator 94. The signal processor 98 implements predetermined signal processing (processing for removing noise components, gain adjustment and A/D conversion) for image data captured by the image sensor 96 in sync with control signals generated from the timing generator 94.

The frame rate of the imaging unit 90 is controlled by the image data compression device 10 or a host (not shown). The frame rate is controlled with control signals corresponding to the set value of the control register 92. The image sensor 96 generates image data of images captured through imaging at a higher frame rate than the generation rate of encoded data of the image data compression device 10. Then, the signal processor 98 outputs image data for which predetermined signal processing such as noise removing has been implemented, as well as a vertical synchronization signal VSYNC indicating the start of one frame.

The set value of the control register 92 can be read out to the outside. The decimation detector 80 of the image data compression device 10 can refer to the set value of the control register 92 to recognize the input frame rate of image data from the imaging unit 90.

Although it is assumed that the set value of the control register 92 can be set from outside, the set value may be fixed in advance.

Referring back to FIG. 8, a further description will be made. The image data compression device 10, which includes the decimation detector 80 capable of referring to the input frame rate of image data from the imaging unit 90, also includes a frame skip unit 60. The frame skip unit 60 implements skip processing for skipping the compression of image data of one frame by the compression processor 70, based on the detection result by the decimation detector 80. More specifically, the frame skip unit 60 implements skip processing on condition that the decimation detector 80 has determined that the input frame is a frame to be decimated. When the skip processing is carried out, the image data of the input frame is not compressed but regarded as null.

The processing by the decimation detector 80 will be explained.

When the input frame rate of image data from the imaging unit 90 is defined as CA (CA is a positive integer), and the generation rate of encoded data that has been compressed by the compression processor 70 is defined as TA (CA>TA, TA is a positive integer), the decimation detector 80 detects, of CA input frames of image data from the imaging unit 90, image data of (CA-TA) frames as a frame to be decimated. That is, if the input frame rate of image data from the imaging unit 90 is high, the decimation detector 80 determines a frame to be decimated at the above rate every time image data of one frame is input. In this manner, the image data compression device 10 decimates input image data by frame prior to compression so as to output encoded data at a certain rate if the input frame rate of image data from the imaging unit 90 is high.

FIG. 10 is an explanatory diagram showing a processing method at the decimation detector 80.

The decimation detector 80 holds a frame decimation interval determined as follows, as decimal data. Then, the decimation detector 80 determines, of image data input from the imaging unit 90, the required number of frames as a frame to be decimated with an interval indicated by the frame decimation interval.

Referring to FIG. 10, with defining the input frame rate of image data as CA and the generation rate of encoded data as TA, required frame decimation numbers and frame decimation intervals when the generation rate of encoded data is 15 (15 frames per second) are shown. The required frame decimation number can be determined by the equation (CA-TA). The frame decimation interval is decimal data that can be determined by the equation CA/(CA-TA).

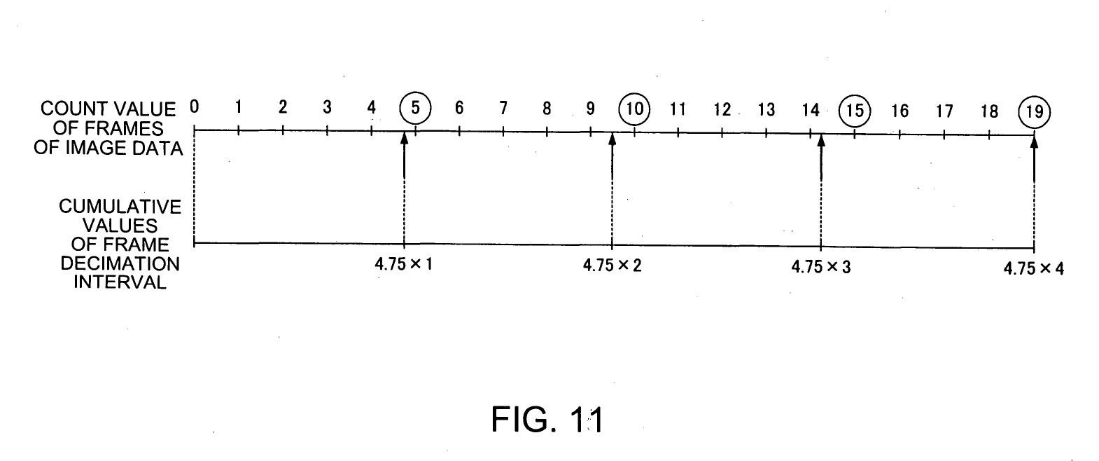

FIG. 11 is an explanatory diagram showing an example of processing by the decimation detector 80.

Referring to FIG. 11, the input frame rate is 19 (19 frames per second) while the generation rate of encoded data is 15 (15 frames per second). In this case, as shown in FIG. 10, the required frame decimation number is 4 (=19−15) while the frame decimation interval is 4.75 (=19/(19−15)).

The decimation detector 80 uses cumulative values of a frame decimation interval in detecting a frame to be decimated. Also, the decimation detector 80 holds a frame count value that is incremented by one every time image data from the imaging unit 90 is input in each frame. The frame count value of image data from the imaging unit 90 is within the range from 0 to CA. Cumulative values of a frame decimation interval are integer multiples of the frame decimation interval and are within the range from 0 to CA. Referring to FIG. 11, the cumulative values of the frame decimation interval are 4.75 (=4.75×1), 9.5 (=4.75×2), 14.25 (=4.75×3) and 19 (=4.75×4).

From the state in which the count value of frames of image data input from the imaging unit 90 is an initial value (=0), whether or not the input frame is a frame to be decimated is determined every time image data is input. More specifically, the decimation detector 80 compares the count value of frames of image data input from the imaging unit 90 with one of frame decimation intervals (one of 4.75, 9.5, 14.25 and 19), which are decimal data determined as integer multiples of CA/(CA-TA). Then, when the count value is equal to or larger than one of the frame decimation intervals, the input frame, which is a frame of image data input from the imaging unit 90, is detected as a frame to be decimated. In other words, when the count value of frames is equal to or larger than one of the cumulative values of the frame decimation interval, the frame is detected as a frame to be decimated. Otherwise, when the count value is larger than one cumulative value of the frame decimation interval and is closest to the cumulative value, the frame is detected as a frame to be decimated.

Referring to FIG. 11, when the count value of frames is 5, the count value is larger than 4.75, which is one of the frame decimation intervals. Therefore, the frame when the count value of frames is 5 is detected as a frame to be decimated. Similarly, when the count value of frames is incremented and becomes 10, 15 or 19, the count value is equal to or larger than 9.5, 14.25 or 19, which is one of cumulative values of the frame decimation interval. Therefore, each frame when the count value of frames is 10, 15 or 19 is detected as a frame to be decimated.

As a result, the compression processor 70 compresses image data of frames when the frame count value is 1-4, 6-9, 11-14 and 16-18.

The compression processor 70 of the image data compression device 10 further includes a rate controller 50 as shown in FIG. 8. The rate controller 50 predicts and determines, from the data size of quantized data of the previous frame of the current frame, the data size of encoded data of the previous frame as predicted data size, so as to vary a quantization step based on the predicted data size. As is apparent from FIG. 5, the enlargement of quantization step leads to the increase of zero data in the quantized DCT coefficients. In contrast, the reduction of quantization step leads to the decrease of zero data in the quantized DCT coefficients. The quantized data whose zero data is thus increased or decreased is written to the FIFO buffer 30. As a result, the size of encoded data into which the encoded data generator 40 has encoded the quantized data read from the FIFO buffer 30 can also be varied depending on a quantization parameter.

As described above, in the rate control method disclosed in MPEG-4 Visual Part (Recommendation report ISO/IEC 14496-2:1999(E) Annex L), it is necessary to reflect the result of encoding of the previous frame in the encoding of the next frame. However, if quantization by the quantizer 20 and encoding by the encoded data generator 40 are assigned to hardware and software, respectively, the processing is implemented asynchronously with each other. Therefore, the quantized data read out from the FIFO buffer 30 may be the data of a frame that is two frames or more previous to the frame whose data is to be quantized at the quantizer 20. As a result, it becomes impossible to realize the rate control method disclosed in MPEG-4 Visual Part (Recommendation report ISO/IEC 14496-2:1999(E) Annex L) in which the result of encoding of the previous frame is reflected in the encoding of the next frame.

Accordingly, in the present embodiment, the rate controller 50 determines the predicted data size of encoded data of the previous frame of the current frame as described above, so as to carry out rate control based on the predicted data size. The predicted data size is determined with focusing attention on the following characteristic in the present embodiment.

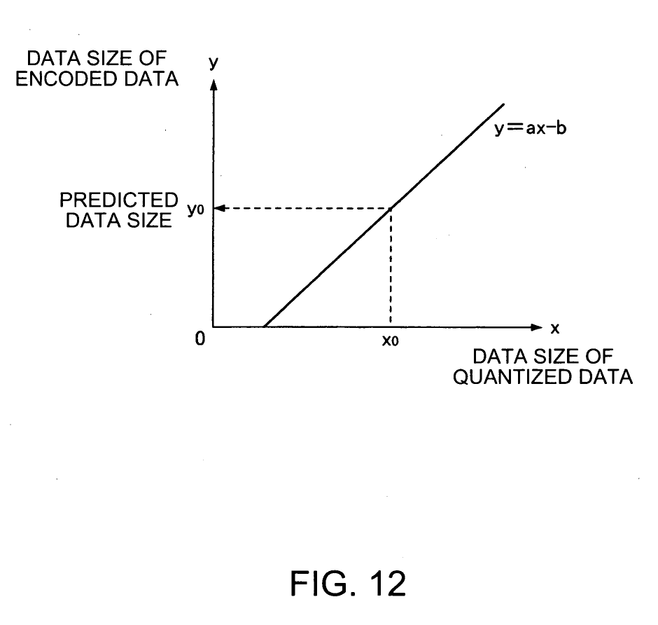

FIG. 12 is an explanatory diagram showing the relationship between the data size of quantized data and the data size of encoded data. Quantized data is data read out from the quantizer 20 and generated in the step S3 in FIG. 1A. Encoded data is data obtained by encoding the quantized data at the encoded data generator 40 and generated in the step S9 in FIG. 1A.

As shown in FIG. 12, the data size of quantized data and the data size of encoded data has a linear relationship. That is, when the data size of quantized data is defined as x and the data size of encoded data is defined as y, y can be approximately determined from the following equation (1) having x as a variable.
y=ax−b (a and b are positive real numbers) (1)

Thus, the linear transformation of the data size x₀ of quantized data allows the predicted value y₀ of data size of encoded data to be determined. In equation (1), a is a coefficient corresponding to the encoding efficiency of the encoded data generator 40. This coefficient is defined depending on the characteristics of processing by the encoded data generator 40. More specifically, the coefficient can also be referred to as a compression coefficient of Huffman encoding implemented at the encoded data generator 40.

In addition, in equation (1), b is a value corresponding to the data size of header information of encoded data generated by the encoded data generator 40. For example, if encoded data is MPEG-4 stream data, the data size of MPEG-4 header information is defined as b. Thus, the linear transformation of equation (1) can also be regarded as a conversion for correction for header size added to encoded data.

The above a and h in equation (1) can be determined through, for example, statistical analysis of the relationship between the data size of quantized data and the data size of encoded data on plural kinds of image data.

By reflecting the predicted data size thus determined as the encoding result of the previous frame in the encoding of the next frame, the rate control method disclosed in MPEG-4 Visual Part (Recommendation report ISO/IEC 14496-2:1999(E) Annex L) is carried out. This enables the compression of image data to achieve both the optimization of sharing by hardware and software, and more accurate rate control.

Although in FIG. 8, predicted data size is determined from the data size of quantized data, the present invention is not limited thereto. Predicted data size can also be determined from information equivalent to the data size of quantized data.

In the following, the number of accesses (number of writing or reading) to the FIFO buffer 30 for each frame is used as information equivalent to the data size of quantized data. Writing to the FIFO buffer 30 is implemented by a unit of a certain number of bits, and thereby the number of accesses of each frame can be used as information equivalent to the data size of quantized data of each frame. Also, reading out from the FIFO buffer 30 is implemented by a unit of a certain number of bits, and thereby the number of accesses of each frame can be used as information equivalent to the data size of quantized data of each frame.

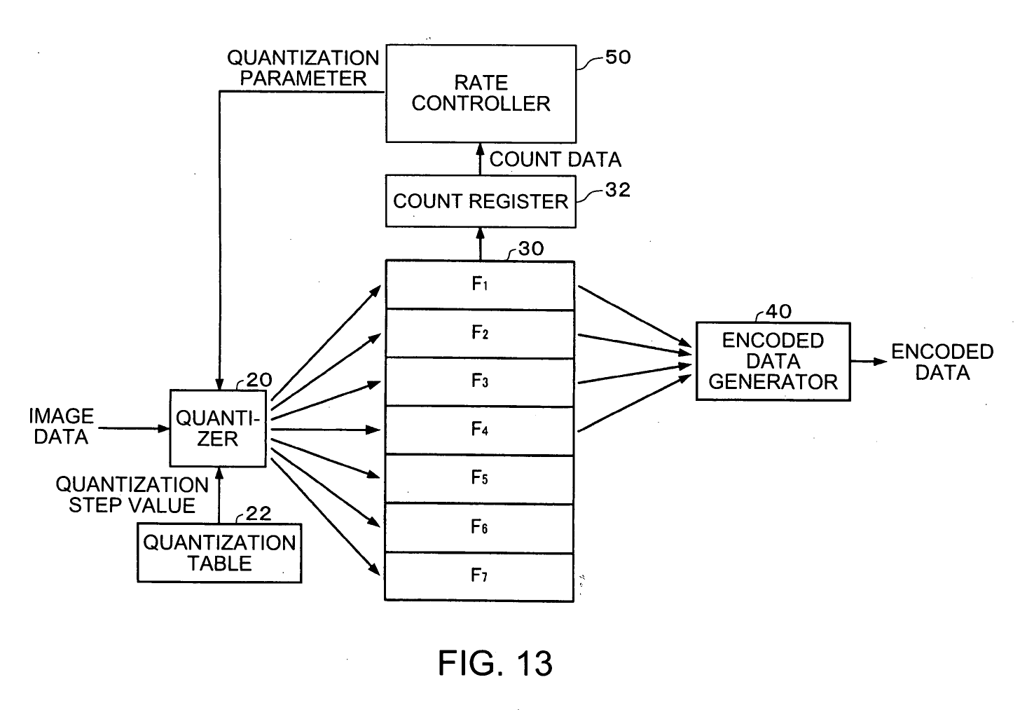

FIG. 13 is an explanatory diagram showing a method of rate control according to the present embodiment. The same parts as those of the image data compression device 10 in FIG. 8 are given the same reference numerals with an explanation thereof being adequately omitted. In FIG. 13, suppose that the FIFO buffer 30 can store quantized data of seven frames.

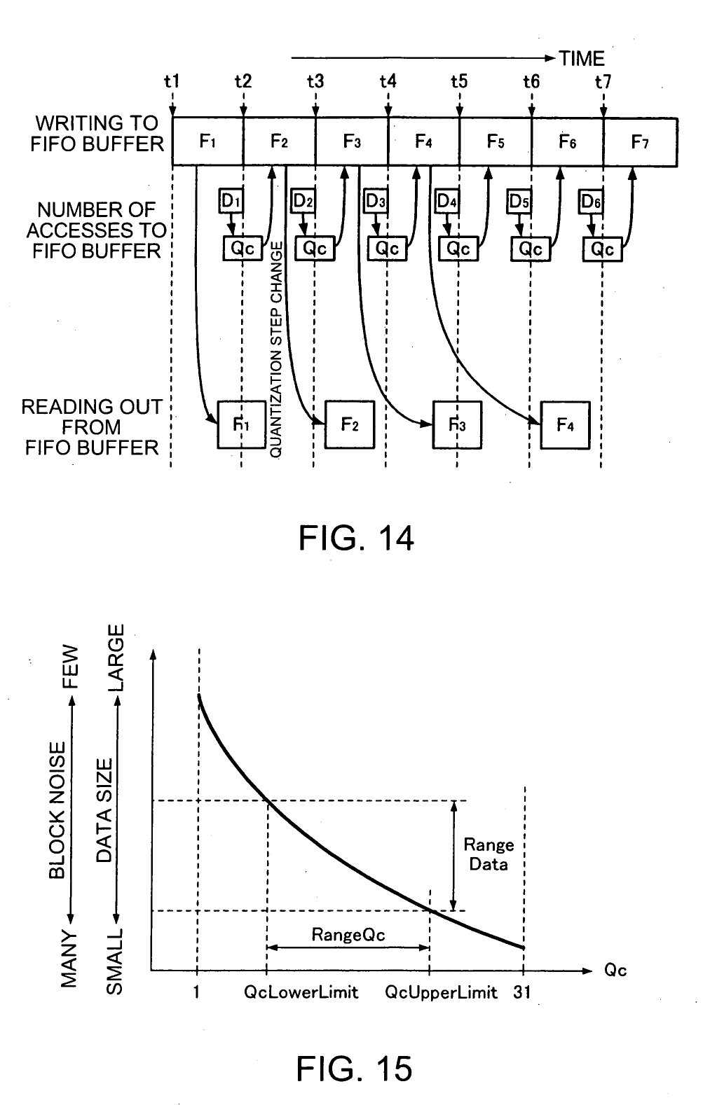

FIG. 14 is a diagram schematically showing the operation timing of the rate control of FIG. 13.

The quantizer 20 quantizes image data in each frame. For example, a quantization table 22 in which the quantization step values shown in FIG. 4 is set is provided. Then, the quantizer 20 quantizes image data in each frame based on the quantization step values set in the quantization table 22 and a quantization parameter from the rate controller 50. Specifically, with using the quantization parameter as a coefficient of the quantization step values, the quantizer 20 carries out quantization by using the product of the quantization parameter and the quantization step values, thereby changing the quantization step.

The quantizer 20 quantizes image data in each frame at time t1, t2, and so on, so as to write quantized data to the FIFO buffer 30 in the order of a first frame F₁, a second frame F₂, and so on. The count data of each frame held by a count register 32 is initialized for each frame. The count data is incremented and updated every time writing to the FIFO buffer 30 occurs. Thus, when the writing of quantized data of each frame has been completed, the count data corresponding to the number of writing to the FIFO buffer 30 is set in the count register 32.

Meanwhile, the encoded data generator 40 reads out quantized data from the FIFO buffer 30 in each frame so as to encode the data, asynchronously with the timing of writing quantized data to the FIFO buffer 30.

The rate controller 50 varies, independently of processing at the encoded data generator 40, the quantization step of the quantizer 20 based on the count data at the time of completion of writing quantized data of each frame, and reflects the varied quantization step in the next frame. Thus, for the next frame of the frame for which the writing of quantized data has been completed, the size of quantized data from the quantizer 20 is changed. Therefore, the size of encoded data generated from the encoded data generator 40 is also changed.

In FIG. 14, the encoded data generator 40 sequentially reads out quantized data of first through fourth frames F₁ through F₄ from the FIFO buffer 30 so as to generate and output encoded data of each frame.

Count data D₁ is held in the count register 32 when the writing of quantized data of the first frame F₁ to the FIFO buffer 30 has been completed. The count data D₁ corresponds to the number of writing of quantized data of the first frame F₁ to the. FIFO buffer 30. The count data D₁ is in correspondence with the data size of quantized data of the first frame F₁. The count data is initialized at the point of start of the second frame F₂, and then count data D₂ is held when the writing of quantized data of the second frame F₂ to the FIFO buffer 30 has been completed. The count data D₂ corresponds to the number of writing of quantized data of the second frame F₂ to the FIFO buffer 30.

The rate controller 50 reads out count data every time the writing to the FIFO buffer 30 has been completed, so as to vary the quantization step of the next frame. Referring to FIG. 14, when the writing of quantized data of the first frame F₁ has been completed, the rate controller 50 reads out the count data D₁ to determine predicted data size from the count data D₁. Then, as described above referring to FIGS. 6 and 7, the rate controller 50 calculates the amount of codes used for encoding the second frame F₂ by using the predicted data size, so as to determine the quantization parameter Qc. As a result, the quantizer 20 quantizes image data of the second frame F₂ by using the product of the quantization step values in the quantization table 22 and the quantization parameter Qc determined based on the predicted data size of encoded data of the first frame F₁. The quantization result is written to the FIFO buffer 30. Thus, encoded data can be generated at a desired rate by using the predicted data size of the previous frame for each frame.

In addition, in the present embodiment, if the data size of encoded data becomes too large to maintain a certain bit rate after the rate control by the rate controller 50, the frame skip unit 60 implements skip processing. The frame skip unit 60 stops the generation of image data to be supplied to the quantizer 20.

The frame skip unit 60 implements skip processing when frames having a quantization parameter, which is determined for each frame, larger than a skip threshold consecutively appear the number of times set as a consecutive skips threshold or more times. Otherwise, the frame skip unit 60 implements skip processing when a complexity threshold is equal to or smaller than the complexity corresponding to information of difference between image data to be quantized by the quantizer 20 and image data of the previous frame of the frame of the image data to be quantized. Thus, the frame skip unit 60 can suppress the increase of encoded data generated for each frame to maintain a bit rate.

Also, there may also be the case in which images obtained by decoding encoded compressed data have not a few block noises depending on encoded images even though rate control is carried out as described above. This is because images obtained by decoding (expanding) the compressed data often have block noises and thus the display quality often deteriorates even if the generation rate of compressed data is controlled by the rate control method disclosed in MPEG-4 Visual Part (Recommendation report ISO/IEC 14496-2:1999(E) Annex L).

FIG. 15 schematically shows the relationship among a quantization parameter, the data size of encoded data and block noises. Referring to FIG. 15, the horizontal axis shows a quantization parameter while the vertical axis shows data size and block noises. In the rate control method disclosed in MPEG-4 Visual Part (Recommendation report ISO/IEC 14496-2:1999(E) Annex L), the range of the quantization parameter Qc is 1-31.

As shown in FIG. 15, the larger quantization parameter leads to the greater decimation of image data for turning DCT coefficients to zero data, and therefore leads to the smaller size of quantized data and encoded data. However, the image obtained by decoding the encoded data has not a few block noises. That is, the smaller data size is, the more block noises appear.

Therefore, in the present embodiment, a quantization parameter upper threshold QcUpperLimit is set so that the quantization parameter Qc does not exceed a certain value. The quantization parameter upper threshold QcUpperLimit is set prior to rate control. Accordingly, the rate controller 50 determines, from the data size of quantized data of the previous frame of the current frame, the predicted data size of encoded data of the previous frame. Then, the rate controller 50 determines a quantization parameter that is at most a settable quantization parameter upper threshold by using the predicted data size. As described above, setting the relationship Qc≦QcUpperLimit can avoid block noises in images obtained by decoding compressed data after encoded even if rate control is carried out.

In contrast, a smaller quantization parameter leads to the smaller amount of decimation of image data, and thus leads to less zero data of DCT coefficients. As a result, the size of quantized data becomes larger and therefore the size of encoded data also becomes larger. However, the image obtained by decoding the encoded data has less block noises. That is, the larger data size is, the less block noises appear. For example, when the quantization parameter Qc is 1, decoded images have the best quality while the amount of data used as encoded data for one frame becomes enormous. In this case, noises of an imaging unit unrecognizable to human's eyes all remain.

Therefore, in the present embodiment, a quantization parameter lower threshold QcLowerLimit is set so that the quantization parameter Qc is not smaller than a certain value. The quantization parameter lower threshold QcLowerLimit is set prior to rate control. Accordingly, the rate controller 50 determines, from the data size of quantized data of the previous frame of the current frame, the predicted data size of encoded data of the previous frame. Then, the rate controller 50 determines a quantization parameter that is at least a settable quantization parameter lower threshold by using the predicted data size. By setting the relationship Qc≧QcLowerLimit as described above, unnecessarily large data size can be avoided even if rate control is carried out.

As described above, the rate controller 50 may determine a quantization parameter by using predicted data size so that the quantization parameter is at most the quantization parameter upper threshold QcUpperLimit or is at least the quantization parameter lower threshold QcLowerLimit. However, the present invention is not limited thereto.

The rate controller 50 may determine a quantization parameter by using predicted data size as descried above so that the quantization parameter is at most the quantization parameter upper threshold QcUpperLimit and is at least the quantization parameter lower threshold QcLowerLimit. In this case, the setting of the quantization parameter Qc within the range RangeQc shown in FIG. 15 allows data size to be set within the range RangeData. Thus, rate control to optimize the relationship between compression efficiency and image quality can easily be realized.

Incidentally, in compression processing for each frame, there is a possibility that the size of encoded data is increased depending on images (images that are not a natural image, particularly) and therefore a bit rate can not be maintained surely. Particularly if the quantization parameter upper threshold QcUpperLimit of the quantization parameter Qc is set as described above, the size of encoded data of respective frames is inevitably increased, leading to a higher possibility of inhibiting the maintenance of a bit rate although the deterioration of image quality can be prevented.

Therefore, the present embodiment is advantageous in that the frame skip unit 60 implements skip processing under certain conditions as described above. Particularly, in the case in which the quantization parameter Qc is determined so as to be at most the quantization parameter upper threshold QcUpperLimit, the frame skip unit 60 implements skip processing when frames having the quantization parameter Qc larger than a skip threshold consecutively appear more than the number of times set as a consecutive skips threshold. Thereby, the deterioration of image quality can be prevented while a bit rate can be maintained surely. Otherwise, in the case in which the quantization parameter Qc is determined so as to be at most the quantization parameter upper threshold QcUpperLimit, the frame skip unit 60 implements skip processing when a complexity threshold is equal to or smaller than the complexity corresponding to information of difference between image data to be quantized by the quantizer 20 and image data of the previous frame of the frame of the image data to be quantized. Thereby, the deterioration of image quality can be prevented while a bit rate can be maintained surely.

3.1 Calculation of Quantization Parameter Qc

The calculation processing of the quantization parameter Qc by the rate controller 50 will be described specifically.

In the following, a quantization parameter is determined by using predicted data size so that the quantization parameter is at most the quantization parameter upper threshold QcUpperLimit and is at least the quantization parameter lower threshold QcLowerLimit.

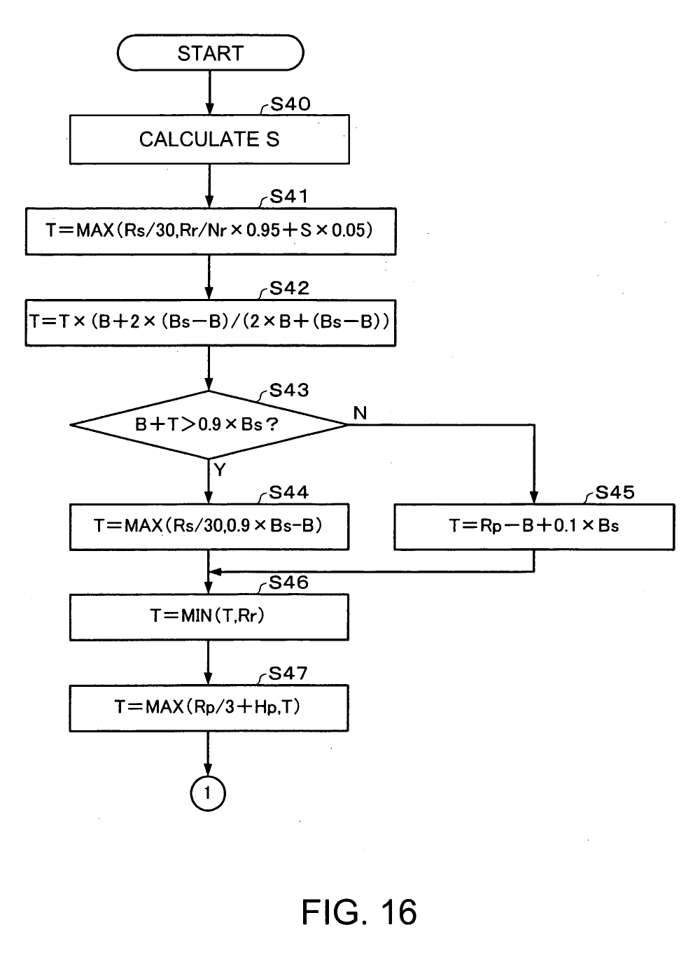

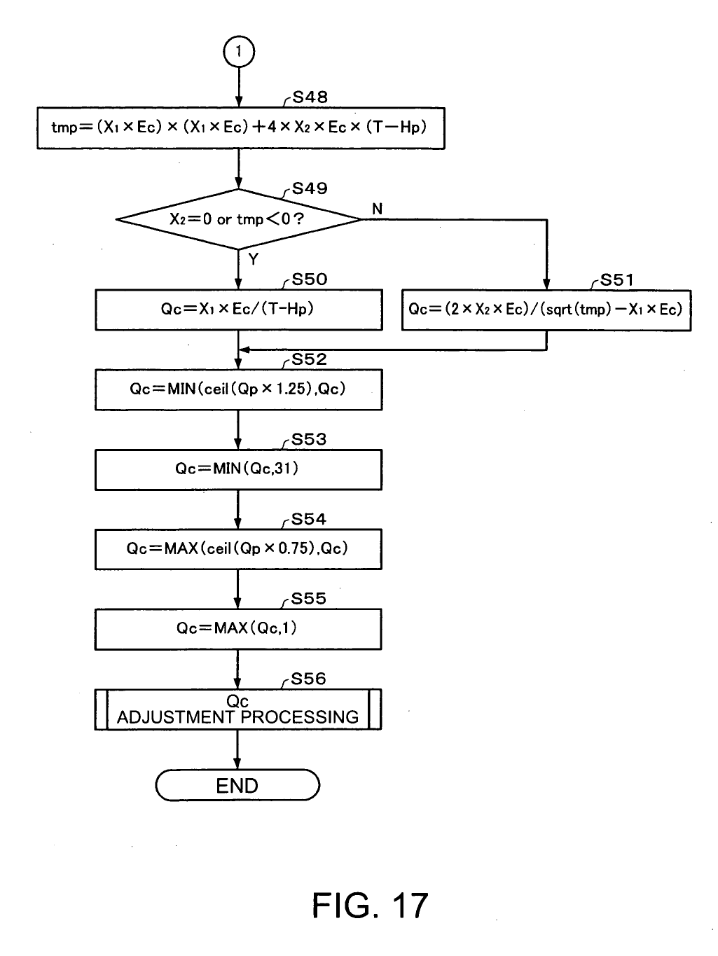

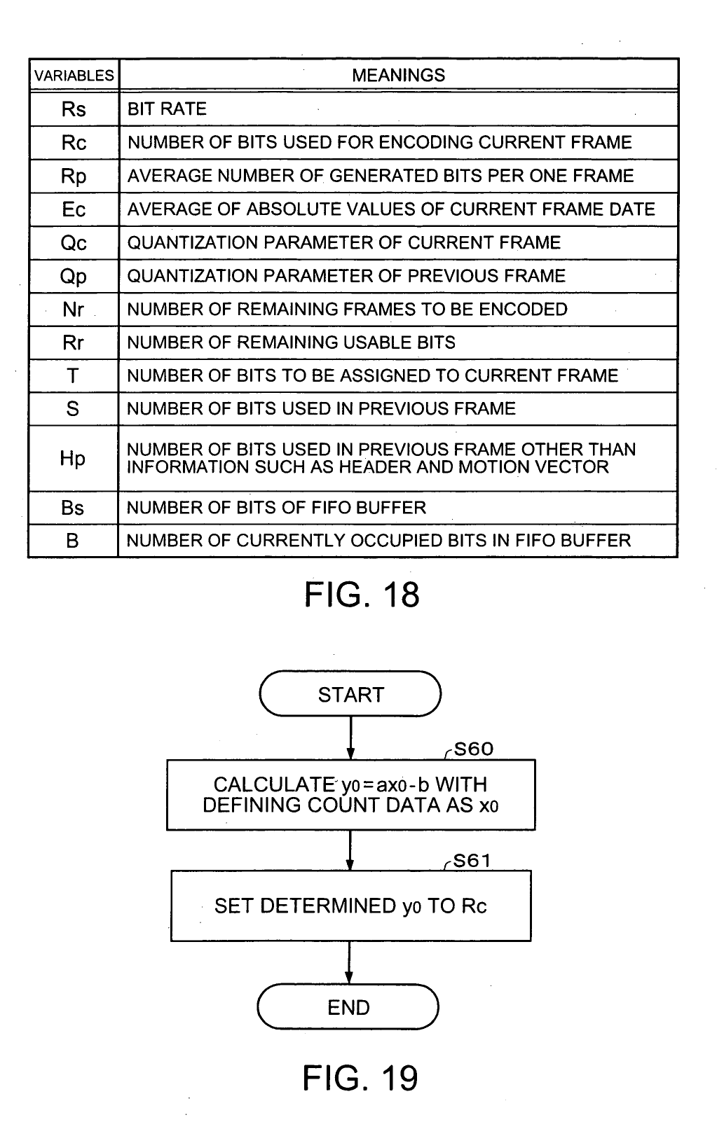

FIGS. 16 and 17 show one example of a flow chart of calculation processing of the quantization parameter Qc. The flow chart shown in FIGS. 16 and 17 will be explained with reference to FIG. 18 showing an explanatory diagram of variables used in the calculation of the quantization parameter Qc. The sequence of the flow chart of FIGS. 16 and 17 is carried out for each frame.

First, the number S of bits used for the previous frame is calculated (step S40). Here, the number Rc of bits used in encoding determined for the previous frame (number of bits used for encoding the current frame) is set for the variable S.

FIG. 19 shows one example of a flow chart of calculation processing for the number Rc of bits used for encoding. The count data read out from the count register 32 as information equivalent to the data size of encoded data of the previous frame of the current frame is defined as x₀. The count data is assigned to x₀ of equation (1) to determine the predicted data size y₀ of encoded data of the current frame (step S60).

Then, the predicted data size y₀ determined in the step S60 is set as the number Rc of bits used for encoding (step S61).

The variable Rc thus determined is set to the variable S for the next frame.

Referring back to FIG. 16, a further description will be made. After the variable S is determined, the number T of bits to be assigned to the current frame is determined (step S41). In the step S41, the average number (Rr/Nr) of assigned bits per one frame is determined from the number Rr of remaining usable bits and the number Nr of remaining frames to be encoded. Then, the number T of bits to be assigned to the current frame is determined based on the ratio of the number (Rr/Nr) to the number S of bits assigned to the previous frame. The ratio is 0.95 to 0.05, for example, in the step S41. Also, the number T of bits to be assigned to the current frame is set so as not to be smaller than Rs/30, which is the lower limit.

Subsequently, the number T of bits to be assigned to the current frame is adjusted based on the ratio of the number B of currently occupied bits in the FIFO buffer 30 to the number Bs of bits of the FIFO buffer 30 (step S42). As a result, the variable T is increased if the number B of currently occupied bits in the FIFO buffer 30 is smaller than the half of the number Bs of bits of the FIFO buffer 30, while the variable T is decreased if B is larger than the half of Bs.

Then, a determination is made as to whether or not the sum of the variable T and the number B of currently occupied bits in the FIFO buffer 30 exceeds 90% of the number Bs of bits of the FIFO buffer 30 (step S43). If a determination is made that the sum exceeds 90% of the variable Bs (step S43: Y), the variable T is set (clipped) to a value obtained by subtracting the variable B from 90% of the number Bs of bits of the FIFO buffer 30 (step S44). That is, the sum of the variable T and the number B of currently occupied bits in the FIFO buffer 30 is set so as not to exceed 90% of the number Bs of bits of the FIFO buffer 30. Also, similarly with the step S41, the variable T is set so as not to be smaller than Rs/30, which is the lower limit.

Meanwhile, if a determination is made that the sum does not exceed 90% of the variable Bs in the step S43 (step S43: N), the variable T is set to a value obtained by subtracting the variable B from the average number Rp of generated bits per one frame, and then adding the resulting value to 10% of the variable Bs (step S45). That is, the value obtained by subtracting the average number Rp of generated bits per one frame from the sum of the variables Bs and T is set so as not to be smaller than 10% of the number Bs of bits of the FIFO buffer 30.

Subsequently to the step S44 or S45, the variable T is set so as not to be larger than the number Rr of remaining usable bits (step S46). Next, the variable T is adjusted so that T does not vary extremely depending on frames (step S47).

Then, in order to determine the quantization parameter Qc, the model formula shown in FIG. 6 is solved as a quadratic with respect to a variable Qc. To that end, first, a variable tmp is determined as shown in FIG. 17 (step S48).

If the model parameter X₂ is 0 or the variable tmp is negative (step S49: Y), the quantization parameter Qc is determined from the model formula being a linear equation (step S50). Here, the variable R has a value obtained by subtracting the number Hp of bits used for the previous frame excluding information of header and so on, from the number T of bits to be assigned to the current frame. Therefore, Qc can be determined from an equation Qc=X₁×Ec/(T−Hp). Also, the variable Ec is the average of absolute values as to pixels of a frame as shown in FIG. 6.

In the step S49, if the model parameter X₂ is not 0 and the variable tmp is equal to or larger than 0 (step S49: N), the solution of the quadratic equation determined from the model formula of FIG. 6 is defined as the quantization parameter Qc (step S51).

Subsequently to the step S50 or S51, processing is implemented so that the difference between the quantization parameter Qc and the quantization parameter Qp of the previous frame is within 25% of Qp and the value of the quantization parameter Qc is any of 1-31 (steps S52, S53, S54 and S55). In the steps S52 and S54, ceil(x) means that value x is rounded up to an integer.

In the present embodiment, the quantization parameter Qc determined in the step S55 is further adjusted (step S56), and thereafter the sequence of processing is completed (end).

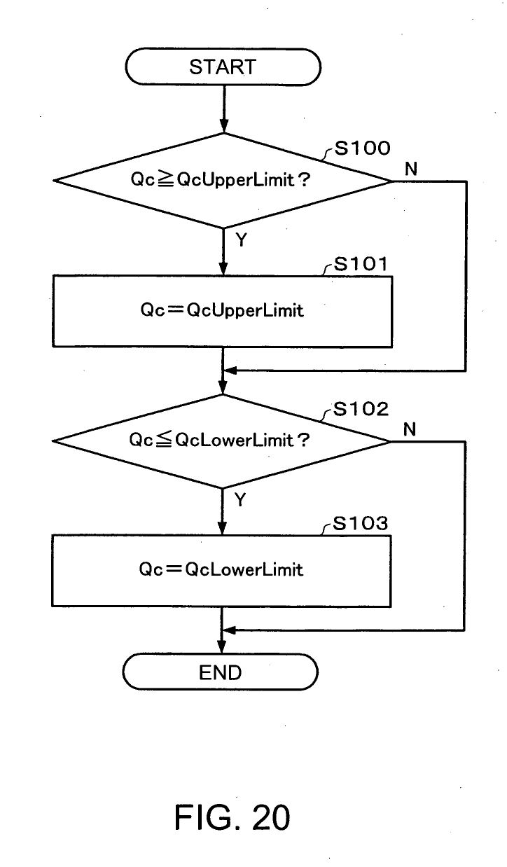

FIG. 20 illustrates one example of a flow chart of adjustment processing of the quantization parameter Qc.

First, a determination is made as to whether or not the quantization parameter Qc determined in the step S55 is equal to or more than the quantization parameter upper threshold QcUpperLimit that is set prior to the adjustment processing (step S100).

If a determination is made that the quantization parameter Qc is equal to or more than the quantization parameter upper threshold QcUpperLimit (step S100: Y), the quantization parameter Qc is set to the quantization parameter upper threshold QcUpperLimit (step S101).

If a determination is made that the quantization parameter Qc is not equal to more than the quantization parameter upper threshold QcUpperLimit (step S100: N), or subsequently to the step S101, a determination is made as to whether or not the quantization parameter Qc is equal to or less than the quantization parameter lower threshold QcLowerLimit that is set prior to the adjustment processing (step S102).

If a determination is made that the quantization parameter Qc is equal to or less than the quantization parameter lower threshold QcLowerLimit (step S102: Y), the quantization parameter Qc is set to the quantization parameter lower threshold QcLowerLimit (step S103).

If a determination is made that the quantization parameter Qc is not equal to or less than the quantization parameter lower threshold QcLowerLimit (step S102: N), or subsequently to the step S103, the current quantization parameter Qc is supplied to the quantizer 20 (end in FIGS. 20 and 17).

The present invention is not limited to the sequence in FIGS. 17 and 20 in which adjustment processing is implemented in the step S56. For example, instead of setting the step S56 in FIG. 17, the value 31 in the step S53 may be replaced by the quantization parameter upper threshold QcUpperLimit while the value 1 in the step S53 may be replaced by the quantization parameter lower threshold QcLowerLimit.

The quantization parameter Qc determined as described above is supplied to the quantizer 20, thereby varying the quantization step of the quantizer 20.

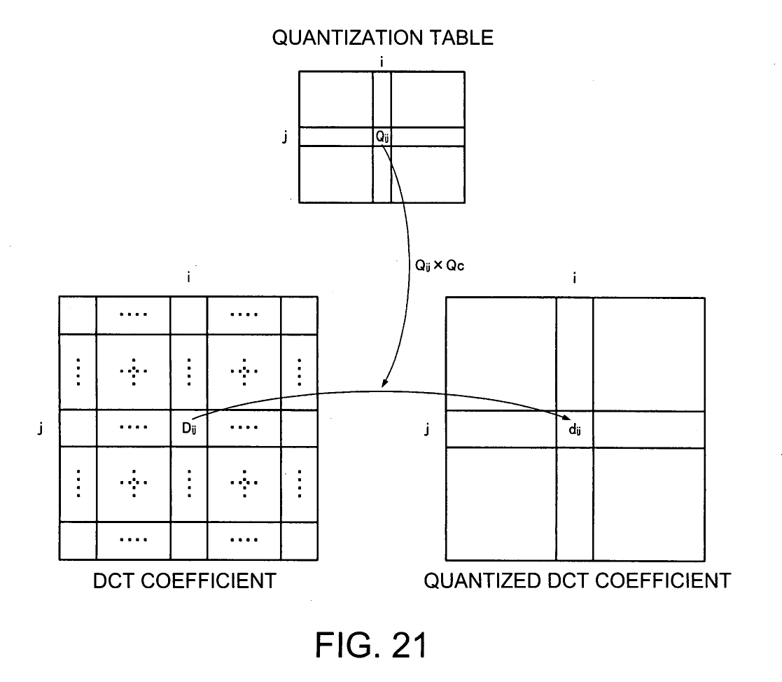

Specifically, as shown in FIG. 21 for example, a DCT coefficient Dᵢⱼ of image data represented by DCT coefficients is divided by the product of the quantization step value Qᵢⱼ on the corresponding position of a quantization table and the quantization parameter Qc to determine the quantized DCT coefficient dᵢⱼ. As a result, the zero data of quantized DCT coefficients can be increased or decreased.

3.2 Frame Skip

The skip processing by the frame skip unit 60 will be described specifically.

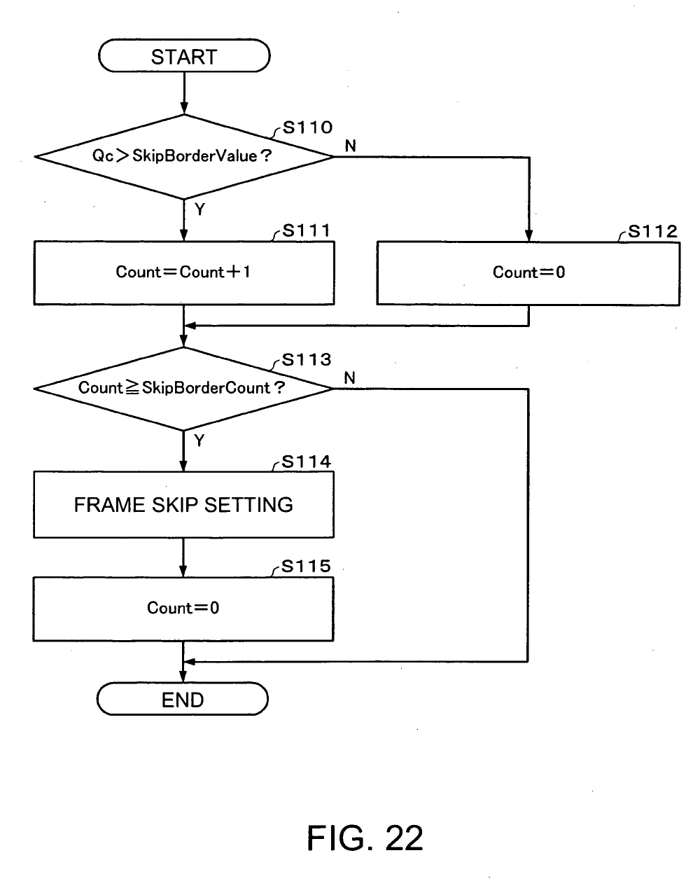

FIG. 22 illustrates a flow diagram of one example of skip processing implemented at the frame skip unit 60. Here, the diagram shows a flow chart for implementing skip processing based on the quantization parameter Qc that has been determined at the rate controller 50 as illustrated referring to FIGS. 16 through 20. The processing sequence of the flow chart shown in FIG. 22 is implemented for each frame, for example.

First, a determination is made as to whether or not the quantization parameter Qc determined at the rate controller 50 is larger than the skip threshold SkipBorderValue (step S110).

If a determination is made that the quantization parameter Qc is larger than the skip threshold SkipBorderValue (step S110: Y), count value Count for counting frames to be skipped is incremented (step S111). If a determination is made that the quantization parameter Qc is equal to or less than the skip threshold SkipBorderValue (step S110: N), the count value Count is set (cleared) to 0 (step S112).

Subsequently to the step S111 or S112, a determination is made as to whether or not the count value Count is equal to or more than the consecutive skips threshold SkipBorderCount (step S113). If a determination is made that the count value Count is equal to or more than the consecutive skips threshold SkipBorderCount (step S113: Y), frame skip setting for skip processing is implemented (step S114). In addition, the count value Count is set to 0 (step S115), and then the sequence of the processing is completed (end).

In the frame skip setting of the step S114, setting for skipping the input of image data to the compression processor 70 is implemented. The frame skip setting permits the initialization of at least a part of the compression processor 70 or the stop of operation clock of at least the part of the compression processor 70, for example. The present invention is not limited to the frame skip setting for skip processing. It is sufficient that encoded data is not generated as a result.

In the step S113, if a determination is made that the count value Count is smaller than the consecutive skips threshold SkipBorderCount (step S113: N), the sequence of the processing is completed (end).

The skip threshold SkipBorderValue and the consecutive skips threshold SkipBorderCount are set prior to the processing shown in FIG. 22.

As described above, the frame skip unit 60 can implement skip processing for skipping encoding when frames having the quantization parameter Qc, which is determined for each frame, larger than the skip threshold SkipBorderValue consecutively appear the number of times set as the consecutive skips threshold SkipBorderCount or more times.

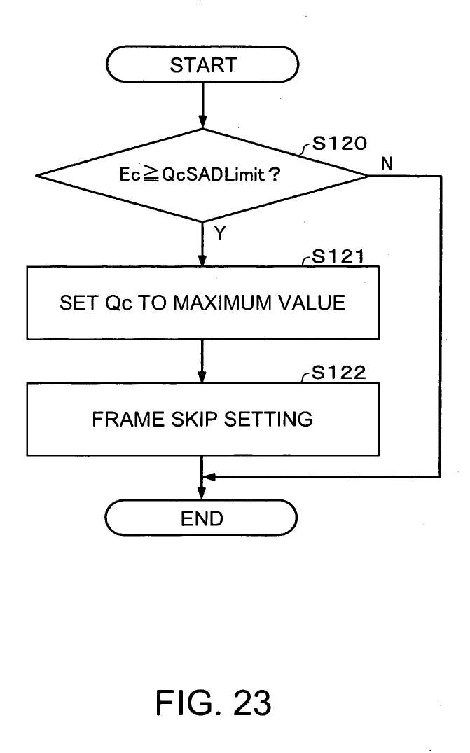

FIG. 23 illustrates a flow diagram of another example of skip processing implemented at the frame skip unit 60. Here, a flow chart for implementing skip processing based on the complexity Ec is illustrated. The processing sequence of the flow chart shown in FIG. 23 is implemented for each frame, for example.

First, the frame skip unit 60 determines whether or not the complexity Ec of the current frame also used for calculating the quantization parameter Qc is equal to or more than the complexity threshold QcSADLimit (step S120). The term current frame refers to a frame of image data to be quantized by the quantizer 20. In addition, the complexity is information corresponding to the difference between image data of the current frame and image data of the previous frame.

If a determination is made that the complexity Ec is equal to or more than the complexity threshold QcSADLimit (step S120: Y), the quantization parameter Qc is set to the maximum value (step S121). The maximum value is “31” in the step S53 of FIG. 17, or the quantization parameter upper threshold QcUpperLimit in the step S101 of FIG. 20. The rate controller 50 carries out rate control by using the quantization parameter Qc that has been set in the step S121.

If the quantization parameter Qc is thus set to the maximum value, frame skip setting for skip processing is implemented (step S122). The frame skip setting is the same as the frame skip setting in the step S114 of FIG. 22.

In the step S120, if a determination is made that the complexity Ec is smaller than the complexity threshold QcSADLimit (step S120: N), the sequence of the processing is completed (end).

The complexity threshold QcSADLimit is set prior to the processing shown in FIG. 23.

As described above, the frame skip unit 60 can implement skip processing when the complexity Ec is equal to or larger than the complexity threshold QcSADLimit.

The frame skip unit 60 is not limited to a unit for implementing the processing shown in FIG. 22 or 23. The frame skip unit 60 may implement the frame skip setting with combining the processing shown in FIGS. 22 and 23 with each other.

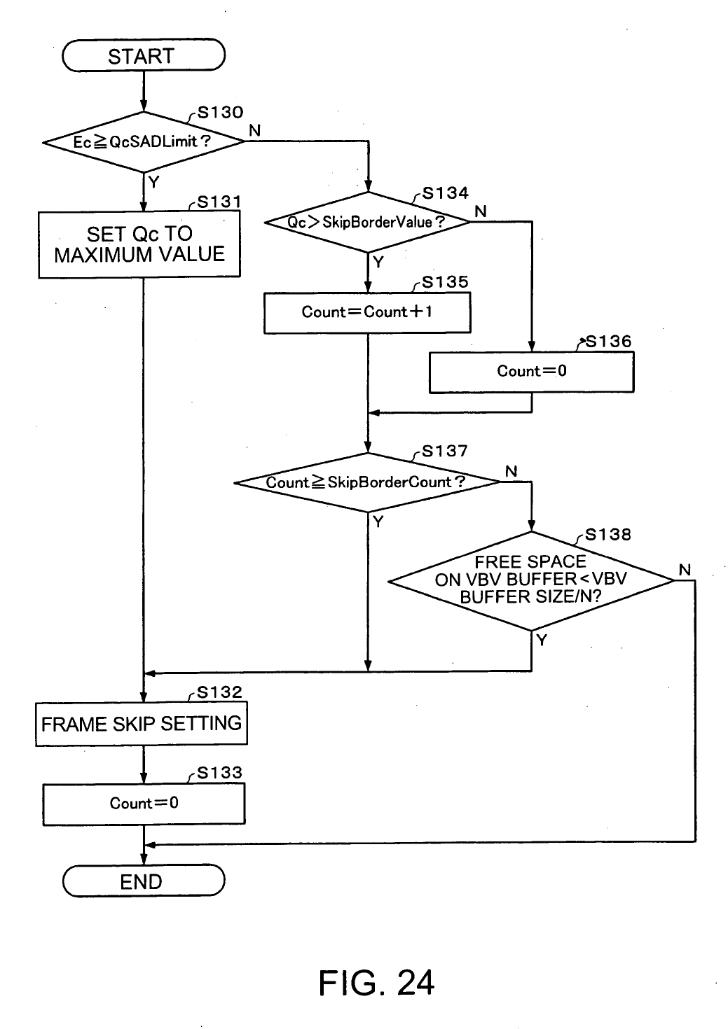

FIG. 24 illustrates a flow diagram of a yet another example of skip processing implemented at the frame skip unit 60. In the sequence of the flow chart, basically, a determination is made as to whether or not skip processing is carried out based on complexity as shown in FIG. 23, and thereafter a determination is made as to whether or not skip processing is carried out based on a quantization parameter as shown in FIG. 22.

Referring to FIG. 24, a virtual buffering verifier referred to as a video buffering verifier (VBV) buffer is provided to implement skip processing for controlling the generation rate of encoded data. The VBV buffer can be a virtual decoder conceptually coupled to the output terminal of the encoded data generator 40. The encoded data generator 40 generates encoded data so that the data does not overflow or underflow at the VBV buffer.

First, the frame skip unit 60 determines whether or not the complexity Ec is equal to or more than the complexity threshold QcSADLimit (step S130). If a determination is made that the complexity Ec is equal to or more than the complexity threshold QcSADLimit (step S130: Y), the quantization parameter Qc is set to the maximum value (step S131). If the quantization parameter Qc is thus set to the maximum value, frame skip setting for skip processing is implemented (step S132). Thereafter, the count value Count for counting frames to be skipped is set to 0 (step S133), and then the sequence of the processing is completed (end). The step S131 is the same as the step S121 while the step S132 is the same as the step S114.

In the step S130, a determination is made that the complexity Ec is smaller than the complexity threshold QcSADLimit (step S130: N), a determination is made as to whether or not the quantization parameter Qc is larger than the skip threshold SkipBorderValue (step S134). If a determination is made that the quantization parameter Qc is larger than the skip threshold SkipBorderValue (step S134: Y), the count value Count is incremented (step S135). If a determination is made that the quantization parameter Qc is equal to or less than the skip threshold SkipBorderValue (step S134: N), the count value Count is set to 0 (step S136).

Subsequently to the step S135 or S136, a determination is made as to whether or not the count value Count is equal to or more than the consecutive skips threshold SkipBorderCount (step S137). If a determination is made that the count value Count is equal to more than the consecutive skips threshold SkipBorderCount (step S137: Y), the sequence moves to the step S132.

In the step S137, if a determination is made that the count value Count is smaller than the consecutive skips value SkipBorderCount (step S137: N), a determination is made as to whether or not the free space on the above-described VBV buffer is smaller than the division of buffer size of the VBV buffer by N (N is a positive integer, for example, N=3) (step S138). If a determination is made that the free space on the VBV buffer is smaller than the division of buffer size of the VBV buffer by N (step S138: Y), the sequence moves to the step S132 to implement skip processing. Meanwhile, if a determination is made that the free space on the VBV buffer is equal to or more than the division of buffer size of the VBV buffer by N in the step S138 (step S138: N), the sequence of the processing is completed (end).

3.3 Configuration Example

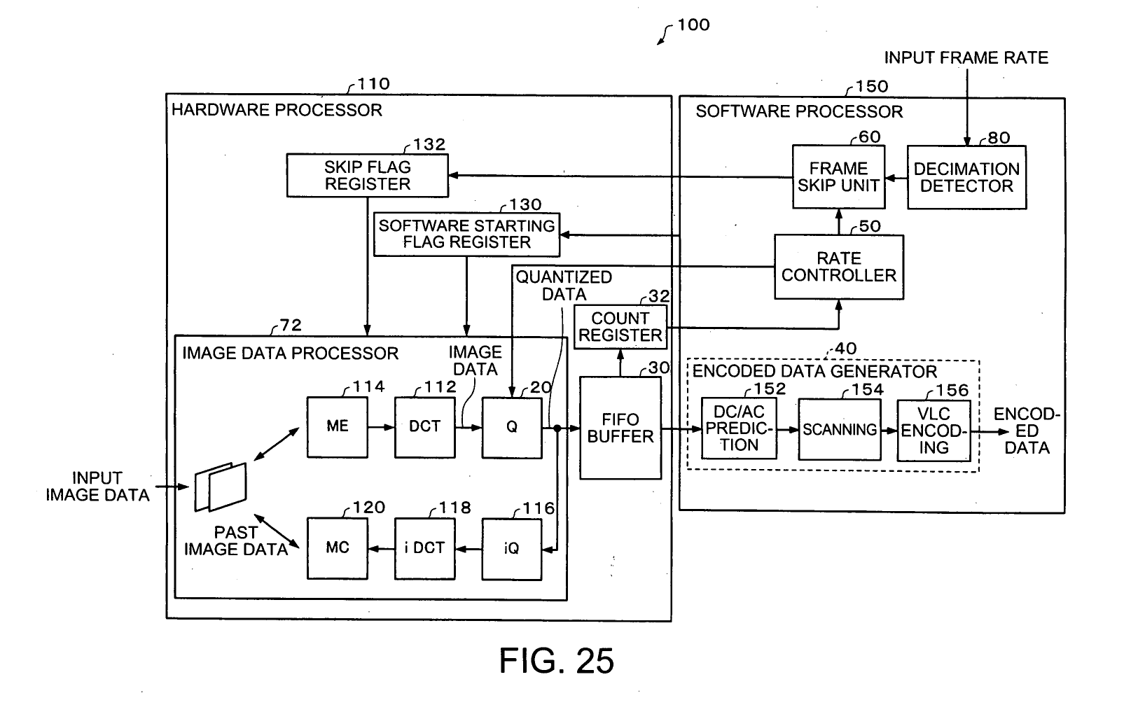

FIG. 25 is a detailed functional block diagram of the image data compression device according to the present embodiment. The same parts as those of the image data compression device 10 shown in FIG. 8 are given the same reference numerals with an explanation thereof being adequately omitted.

An image data compression device 100 shown in FIG. 25 implements compression processing for image data of moving images compliant with MPEG-4. The image data compression device 100 includes a hardware processor 110 and a software processor 150.

The hardware processor 110 processes image data of moving images by means of hardware. The hardware processor 110 includes an image data processor 72 having the quantizer 20, the FIFO buffer 30, a software starting flag register 130 and a skip flag register 132. The hardware processor 110 is realized with hardware such as ASICs or dedicated circuits without using software.

The software processor 150 encodes quantized data read out from the FIFO buffer 30 by means of software so as to generate encoded data. The software processor 150 includes the encoded data generator 40, the rate controller 50, the frame skip unit 60 and the decimation detector 80. The software processor 150 is a processor whose function is realized with software (firmware). The function of the software processor 150 is realized with a CPU or the like (hardware) reading in software (firmware).

More specifically, the image data processor 72 of the hardware processor 110 includes a discrete cosine transform (DCT) unit 112, a motion estimator 114, an inverse quantizer 116, an inverse DCT unit 118, and a motion compensator 120. The DCT unit 112 implements the processing in the step S2 shown in FIG. 1A. The motion estimator 114 implements the processing in the step S1 shown in FIG. 1A. The inverse quantizer 116 implements the processing in the step S4 shown in FIG. 1A. The inverse DCT unit 118 implements the processing in the step S5 shown in FIG. 1A. The motion compensator 120 implements the processing in the step S6 shown in FIG. 1A.

That is, the hardware processor 110 outputs the difference between the input image data of the current frame and the past image data of the previous frame of the current frame as motion vector information. Then, the hardware processor 110 implements discrete cosine transform for the motion vector information to output the transformed information to the quantizer as image data. Furthermore, the above-described past image data is generated based on inverse-quantized data determined by inverse-quantizing the quantized data with the above-described quantization step.

The processing by the hardware processor 110 starts when the software starting flag register 130 is set. The software starting flag register 130 is set by the software processor 150. Specifically, in interrupt processing to indicate the start of supply of input image data, the software processor 150 sets the software starting flag register 130 (sets software starting flag information to a set state).

Meanwhile, when the skip flag register 132 is set, the generation of image data is skipped in the image data processor 72. Specifically, when the frame skip unit 60 determines to implement skip processing under the above-described conditions, the software processor 150 (frame skip unit 60) sets the skip flag register 132 (sets skip flag information to a set state). The skip flag register 132 is set to a reset state for each frame. In this case, the skip flag register 132 may be reset (set to a reset state) by hardware, or may be reset by the software processor 150 for each frame.

The hardware processor 110 need not include all elements described above. At least one of the elements may be omitted.

The encoded data generator 40 of the software processor 150 includes a DC/AC predictor 152, a scan unit 154 and a VLC encoder 156. The DC/AC predictor 152 implements the processing in the step S7 shown in FIG. 1A. The scan unit 154 implements the processing in the step S8 shown in FIG. 1A. The VLC encoder 156 implements the processing in the step S9 shown in FIG. 1A.

The software processor 150 need not include all elements described above. At least one of the elements may be omitted. For example, the software processor 150 may encode quantized data read out from the FIFO buffer 30 into variable length codes. Also, the software processor 150 may implement scan processing for rearranging quantized data read out from the FIFO buffer 30 and encode the result of the scan processing into variable length codes. Furthermore, the software processor 150 may determine DC and AC components from quantized data read out from the FIFO buffer 30 and implement scan processing for rearranging the DC and AC components, and then may encode the result of the scan processing into variable length codes.

The following description explains the reason for that the steps S1 through S6 of FIG. 1A are processed by hardware while the steps S7 through S10 are processed by software in the present embodiment. First, after quantization in the step S3 of FIG. 1A, the amount of zero data in each block is greatly large as shown in FIG. 5 and greatly less kinds of information amounts of data are included compared with data before quantization (FIG. 3). In addition, the load of calculation itself in the steps S7 through S10 is small. Therefore, even if the steps S7 through S10 of FIG. 1A are processed by software, the load of the processing is small. In contrast, in quantization of the step S3, DCT of the step S2, inverse DCT of the step S5, and so on in FIG. 1A, the information amount is large and calculation is complicated, causing a heavy load for software processing. Although the quantization, DCT, inverse DCT, motion compensation and so on cause a heavy load, the standards of these calculations are fixed and therefore the necessity for modification is small. Also, the steps S1 through S6 in FIG. 1A involve much repeat processing. Thus, these calculations are suitable for hardware processing. In addition, since the amount of quantized data processed at the hardware processor 110 is small as described above, the amount of data transmitted from the hardware processor 110 to the software processor 150 is small and thus the load of data transmission control is light.

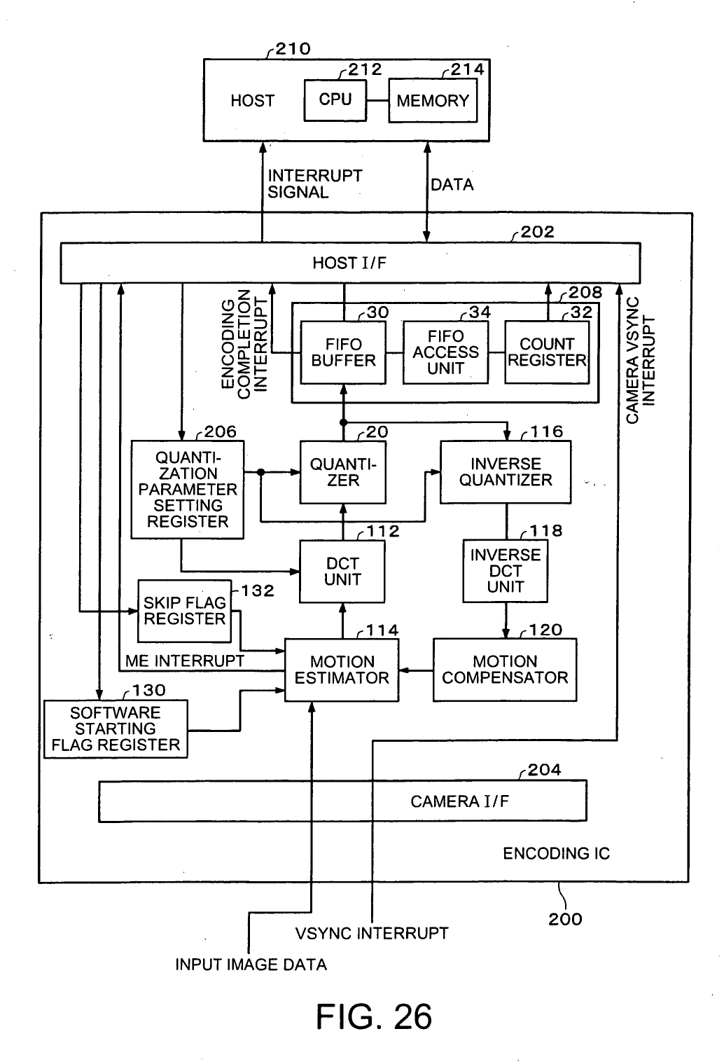

FIG. 26 illustrates a hardware configuration example of the image data compression device 100. In the drawing, the hardware processor 110 shown in FIG. 25 is integrated and is incorporated in a semiconductor device as an encoding integrated circuit (IC) (encoder in the broad sense) 200. The function of the software processor 150 is achieved with a host 210. In FIG. 26, the same parts as those of the hardware processor 110 shown in FIG. 25 are given the same numerals with the description thereof being adequately omitted.

The host 210 includes a CPU 212 and a memory 214. The memory 214 stores a program for realizing the functions of the encoded data generator 40, the rate controller 50, the frame skip unit 60 and the decimation detector 80. The CPU 212 reads out the program stored in the memory 214 so as to implement processing based on the program, and thereby realizing the functions of the encoded data generator 40, the rate controller 50, the frame skip unit 60 and the decimation detector 80.

The encoding IC 200 encodes image data of moving images obtained through imaging by a camera module (imaging unit in the broad sense, not shown) in compliant with the MPEG-4 standard so as to generate encoded data at a certain rate. For this purpose, the encoding IC 200 includes, in addition to circuits for realizing the functions of the elements in the hardware processor 110 shown in FIG. 25, a host interface (I/F) 202, a camera I/F (image input I/F in the broad sense) 204, a quantization parameter setting register 206, the software starting flag register 130 and the skip flag register 132.

The processing by the host 210 sets the skip flag register 132. If the skip flag register 132 is set, the generation of image data at the image data processor 72 is skipped. In FIG. 26, if the skip flag register 132 is set, the inner state of the motion estimator 114 is initialized, and thereby the generation of image data at the image data processor 72 is skipped.

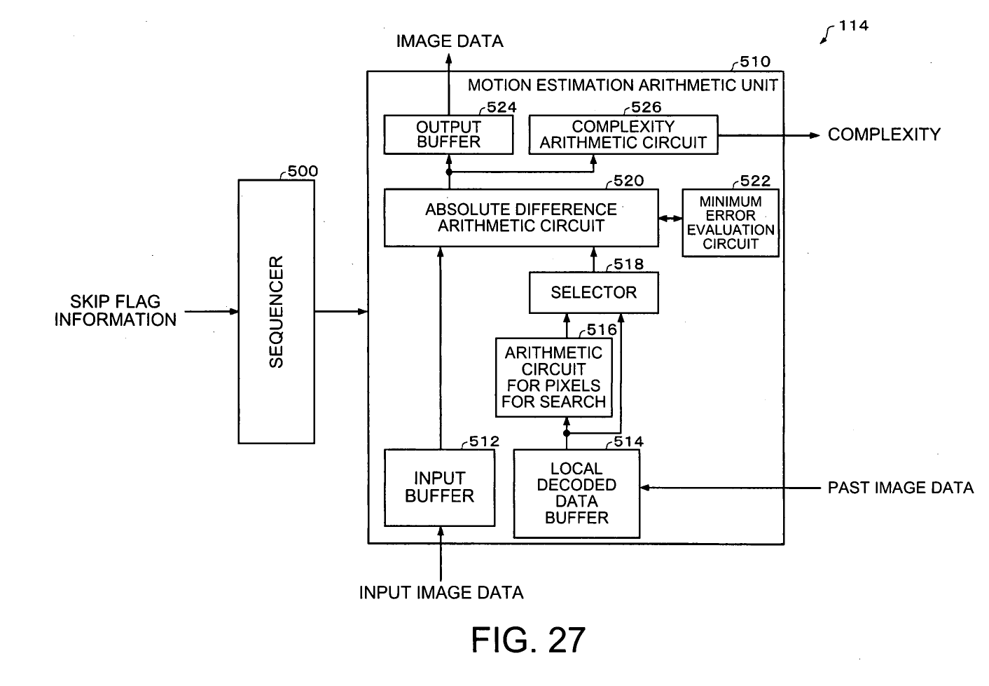

FIG. 27 illustrates a hardware configuration example of the motion estimator 114 of FIG. 26. The present invention is not limited to the configuration of the motion estimator 114 shown in FIG. 27.

The motion estimator 114 includes a sequencer 500 and a motion estimation arithmetic unit 510. The motion estimation arithmetic unit 510 calculates motion vector information and so on based on control signals from the sequencer 500 to output the calculated information to the DCT unit 112 as image data. The sequencer 500 transits among predetermined plural states and outputs control signals in each state, and thereby controlling each part of the motion estimation arithmetic unit 510 so as to control processing for motion estimation.

In the motion estimation arithmetic unit 510, input image data is held in an input buffer 512. Also, past image data from the motion compensator 120 is held in a local decoded data buffer 514. The motion estimator 114 outputs motion vector information at the time when the sum of absolute difference of each pixel between input image data and past image data becomes the minimum value. For this purpose, an arithmetic circuit 516 for pixels for search determines pixel values for search (for example, the average value of brightness components of adjacent two points or four points) as to pixels of the past image data held in the local decoded data buffer 514. Then, a selector 518 outputs either the output from the arithmetic circuit 516 or the output from the local decoded data buffer 514.

An absolute difference arithmetic circuit 520 determines the sum of absolute differences between the pixels of image input data held in the input buffer 512 and the pixels of output from the selector 518 for each macroblock, for example. A minimum error evaluation circuit 522 determines whether or not the sum of absolute differences is the minimum value. If the minimum error evaluation circuit 522 determines that the calculation result by the absolute difference arithmetic circuit 520 is the minimum value, the minimum error evaluation circuit 522 outputs the calculation result to an output buffer 524. That is, the value of pixels of past image data or the value of pixels for search is calculated repeatedly so that the calculation result by the absolute difference arithmetic circuit 520 become the minimum value in the evaluation by the minimum error evaluation circuit 522.

Motion vector information thus output to the output buffer 524 is supplied to the DCT unit 112 as image data. A complexity arithmetic circuit 526 determines the complexity Ec as described above and outputs the complexity Ec to the host 210.

The skip flag information of the skip flag register 132 is input to the sequencer 500 of the motion estimator 114. When the skip flag information is set to a set state, the sequencer 500 returns the inner state of the motion estimation arithmetic unit 510 to an initial state. That is, when the skip flag register 132 is set, the motion estimator 114 can immediately stop motion estimation processing.

In the present embodiment, although the FIFO buffer 30 is included as described above, the data size of encoded data can be predicted as predicted data size from the number of accesses to the FIFO buffer 30, and thereby a bit rate can be controlled based on the predicted data size. In addition, if a determination is made that a certain bit rate can not be realized, the processing by the motion estimator 114 can be stopped for skipping the generation of image data. That is, the predicted data size of encoded data of the previous frame is determined from the data size of quantized data of the previous frame of the current frame, and thus the generation of image data of the current frame can be skipped based on the predicted data size.

Referring to FIG. 26, the encoding IC 200 includes a FIFO unit 208. The FIFO unit 208 has the FIFO buffer 30, the count register 32 and the FIFO access unit 34. The FIFO access unit 34 controls the writing of quantized data from the quantizer 20 to the FIFO buffer 30, while updates count data held in the count register 32. More specifically, the FIFO access unit 34 controls the writing of quantized data by a unit of certain bytes to the FIFO buffer 30. Also, the FIFO access unit 34 increments count data to update the count register 32 every time the FIFO access unit 34 controls the writing to the FIFO buffer 30. When the writing of quantized data of one frame to the FIFO buffer 30 has been completed, the information as to the number of writing (the number of accesses) corresponding to the data size of the quantized data is held in the count register 32.

The encoding IC 200 and the host 210 exchange interrupt signals and data with each other, thereby realizing the function of the image data compression device shown in FIGS. 8 and 25.

The host I/F 202 implements interface processing between the encoding IC 200 and the host 210. Specifically, the host I/F 202 generates interrupt signals from the encoding IC 200 to the host 210 and controls the exchange of data between the host 210 and the encoding IC 200. The host I/F 202 is coupled to the FIFO buffer 30 and the count register 32.

The camera I/F 204 implements interface processing for inputting input image data of moving images from a camera module (not shown). The camera I/F 204 is coupled the motion estimator 114.

The camera module (not shown) supplies image data of moving images obtained through imaging to the encoding IC 200 as input image data. At this time, the camera module also supplies to the encoding IC 200 VSYNC signals (vertical synchronization signal) to specify the separation of frames of input image data. In the encoding IC 200, when the camera I/F 204 receives the VSYNC signal from the camera module as a VSYNC interrupt, the VSYNC interrupt is sent via the host I/F 202 to the host 210 as a camera VSYNC interrupt. Thus, prior to the start of encoding, the host 210 can implement certain adjunctive processing.

Referring to FIG. 26, quantized data of at least one frame is written to the FIFO buffer 30 at the stage of motion estimation. When the motion estimation by the motion estimator 114 has been completed, the motion estimator 114 informs the host 210 of a motion estimation completion interrupt (ME interrupt) via the host I/F 202.

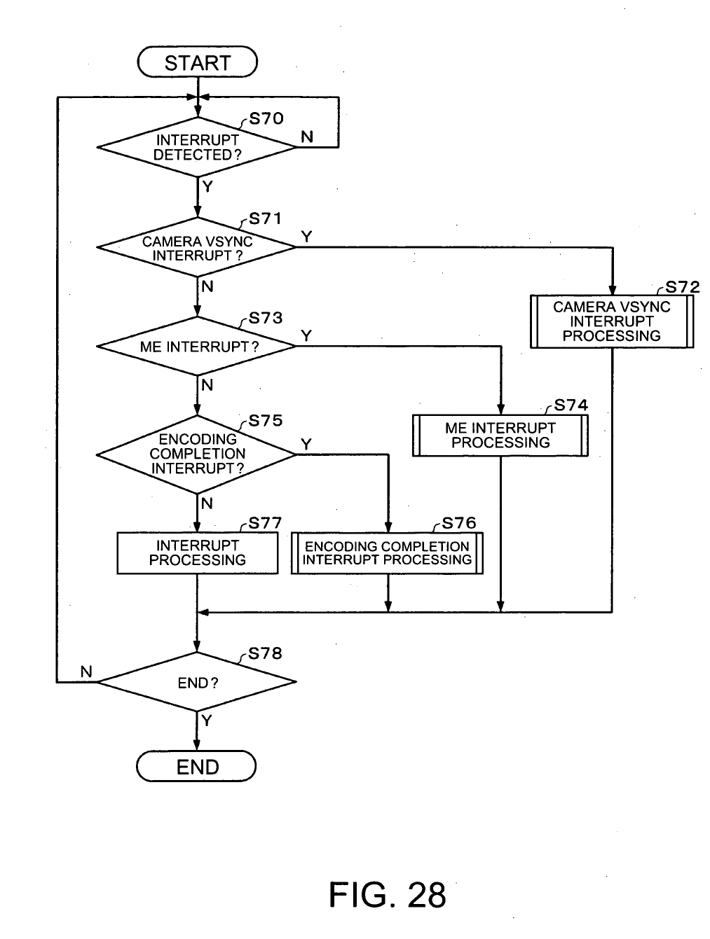

FIG. 28 illustrates one example of a flow chart of interrupt reception processing implemented at the host 210. The memory 214 stores a program for realizing the processing shown in FIG. 28. The CPU 212 reads in the program to realize the processing shown in FIG. 28.

First, the CPU 212 monitors an interrupt input (step S70: N). If the CPU 212 detects an interrupt (step S70: Y), the CPU 212 determines whether or not the interrupt is the camera VSYNC interrupt to be described later (step S71).

If the CPU 212 determines that the interrupt is the camera VSYNC interrupt (step S71: Y), the CPU 212 implements camera VSYNC interrupt processing to be described later (step S72).

If the CPU 212 determines that the interrupt is not the camera VSYNC interrupt in the step S71 (step S71: N), the CPU 212 determines whether or not the interrupt is the ME interrupt to be described later (step S73).

If the CPU 212 determines that the interrupt is the ME interrupt (step S73: Y), the CPU 212 implements ME interrupt processing to be described later (step S74).

If the CPU determines that the interrupt is not the ME interrupt in the step S73 (step S73: N), the CPU 212 determines whether or not the interrupt is an encoding completion interrupt to be described later (step S75). If the CPU 212 determines that the interrupt is the encoding completion interrupt (step S75: Y), the CPU 212 implements encoding completion interrupt processing to be described later (step S76).

If the CPU 212 determines that the interrupt is not the encoding completion interrupt in the step S75 (step S75: N), the CPU 212 implements certain interrupt processing (step S77).

If, subsequently to the step S72, S74, S76 or S77, the sequence is not to be completed (step S78: N), the sequence returns to the step S70. If the sequence is to be completed (step S78: Y), the sequence of the processing is completed (end).

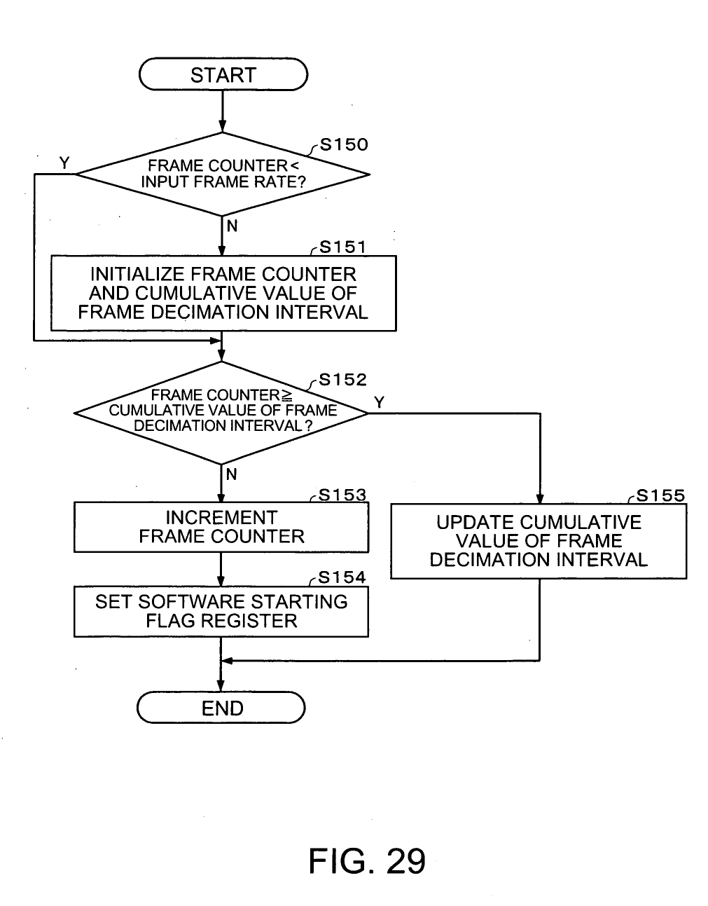

FIG. 29 illustrates one example of a flow chart of camera VSYNC interrupt processing. The memory 214 stores a program for realizing the processing shown in FIG. 29. The CPU 212 reads in the program to realize the processing shown in FIG. 29.

The camera VSYNC interrupt processing is implemented in the step S72 of FIG. 28. Here, it is assumed that the cumulative values of a frame decimation interval are determined at least once prior to the processing of FIG. 29.

The CPU 212 determines that image data of one frame from a camera module (imaging unit) is input every time VSYNC interrupt processing is implemented. The CPU 212 holds frame count value to be updated as a (camera) frame counter. Then, the CPU 212 determines whether or not the frame counter is smaller than the camera input frame rate (for example, 19 frames per second, which is the input frame rate of image data of FIG. 11) (step S150).

If a determination is made that the frame counter is not smaller than the camera input frame rate (step S150: N), the frame counter and the cumulative value of a frame decimation interval are initialized (step S151). In the example described referring to FIG. 11, the frame counter is set to 0 and the cumulative value of a frame decimation interval is set to 4.75.

If a determination is made that the frame counter is smaller than the camera input frame rate in the step S150 (step S150: Y), or subsequently to the step S151, the CPU 212 determines whether or not the frame counter is equal to or more than one of the cumulative values of the frame decimation interval (step S152). In the example described referring to FIG. 11, the cumulative value of the frame decimation interval is 4.75 and is compared with the frame counter.

If a determination is made that the frame counter is not equal to or more than one of the cumulative values of the frame decimation interval in the step S152 (step S152: N), the input frame is determined to be a frame not to be decimated and the frame counter is incremented by one (step S153). Subsequently, the software starting flag register 130 is set via the host I/F 202 (step S154), while the sequence of the processing is completed (end).

If a determination is made that the frame counter is equal to or more than one of the cumulative values of the frame decimation interval in the step S152 (step S152: Y), the input frame is determined to be a frame to be decimated and the cumulative value of the frame decimation interval is updated (step S155). Then, the sequence of the processing is completed (end). That is, if the input frame is determined to be a frame to be decimated, the software starting flag register 130 is not set and encoding for image data of the frame is not implemented. In the example of FIG. 11, the cumulative value of the frame decimation interval is sequentially updated in the order of 4.75, 9.5, 14.25 and 19 every time the step S155 is implemented.

As described above, the present embodiment has, in rough classification, two kinds of skip processing.

The first skip processing is achieved by operating the skip flag register 132. Whether or not the skip processing is implemented is determined in the processing shown in FIGS. 22 through 24. The skip processing allows a certain bit rate to be maintained surely.

The second skip processing is achieved by omitting the setting of the software starting flag register 130. This skip processing is implemented as long as the input frame rate of image data from an imaging unit is higher than the generation rate of encoded data. The skip processing allows the generation of encoded data at a lower certain rate for image data from an imaging unit with a high frame rate.

It is desirable that the above-described one or plural cumulative values of the frame decimation interval is determined prior to the detection of frames to be decimated (processing by the decimation detector or the step S152 of FIG. 29) on condition that the input frame rate of image data from a camera module (imaging unit) has varied. In this case, the necessity to frequently determine cumulative values is eliminated while the response to the input frame rate of a variable camera module is also possible.

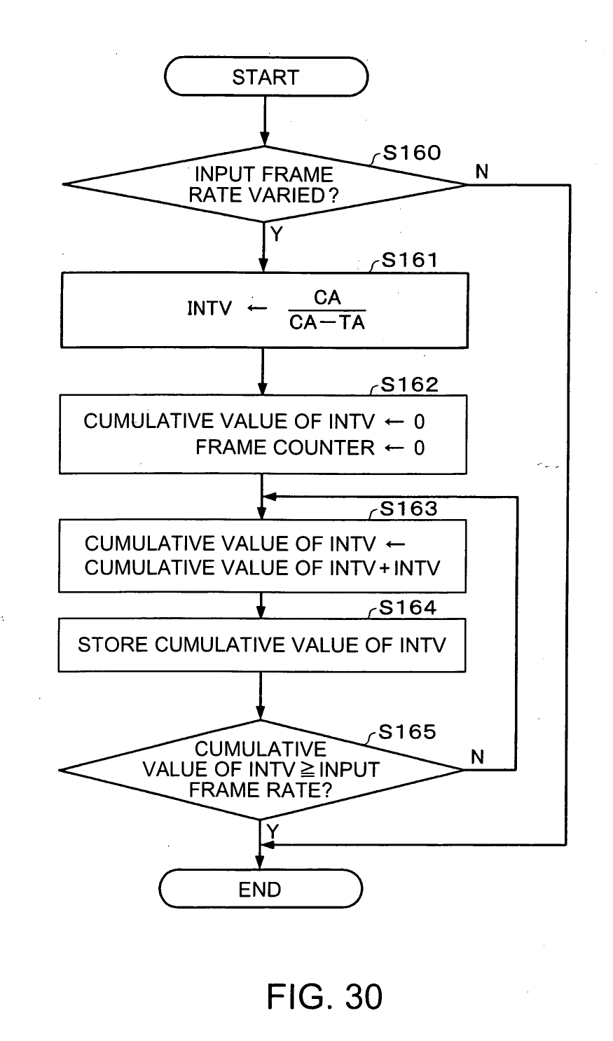

FIG. 30 illustrates one example of a flow chart of processing for determining cumulative values of a frame decimation interval. This processing is desirably implemented during VSYNC interrupt processing. In the diagram, similarly with to FIG. 10, the input frame rate of image data from a camera module is defined as CA while the generation rate of encoded data is defined as TA. A frame decimation interval is defined as INTV.

First, the CPU 212 determines whether or not the input frame rate of image data from a camera module has varied (step S160). The CPU 212 directly accesses a camera module having a configuration block shown in FIG. 9, for example, to refer to the set value of the control register 92, thereby determining whether or not the input frame rate has varied. Otherwise, the CPU 212 indirectly refers to the set value of the control register 92 via the encoding IC 200 for a camera module having a configuration block shown in FIG. 9, for example, thereby determining whether or not the input frame rate has varied.

If a determination is made that the input frame rate of image data from a camera module has varied in the step S160 (step S160: Y), CA/(CA-TA), which is decimal data, is set in INTV (step S161).

Subsequently, the cumulative value of INTV and the frame counter are set to 0 (step S162).

Thereafter, the sum of the cumulative value of INTV and INTV is set in the cumulative value of INTV (step S163). The cumulative value of INTV in which the sum is set is stored (step S164).

Then, a determination is made as to whether or not the cumulative value of INTV determined in the step S163 is equal to or more than the input frame rate from a camera module (step S165). If the cumulative value of INTV determined in the step S163 is not equal to or more than the input frame rate from a camera module (step S165: N), the sequence returns to the step S163.

If the cumulative value of INTV determined in the step S163 is equal to or more than the input frame rate from a camera module (step S165: Y) or if a determination is made that the input frame rate of image data from a camera module does not vary in the step S160 (step S160: N), the sequence of processing is completed (end).

Thus, in the example of FIG. 11, 4.75, 9.5 (=4.75+4.75), 14.25 (=9.5+4.75) and 19 (=14.25+4.75) are stored as the cumulative values of INTV since INTV is 4.75 and the input frame rate is 19.

In FIG. 30, an explanation has been made about the case in which the input frame rate of image data from a camera module is variable. However, if the input frame rate is fixed, the cumulative values of INTV may be determined during the initialization processing of the camera module prior to the detection of frames to be decimated.

Referring back to FIG. 26, a further description will be made. When the software starting flag register 130 is set by the host 210 via the host I/F 202, encoding is started in the encoding IC 200.

The motion estimator 114 does not implement motion estimation for the first input image data loaded after the start of encoding. The motion estimator 114 implements motion estimation after the input image data of the next frame is loaded. Since the details of motion estimation are as above, the description of operation of the inverse quantizer 116 and so on will be omitted. When the motion estimation by the motion estimator 114 has been completed, the motion estimator 114 informs the host 210 of a motion estimation completion interrupt (ME interrupt) via the host I/F 202.

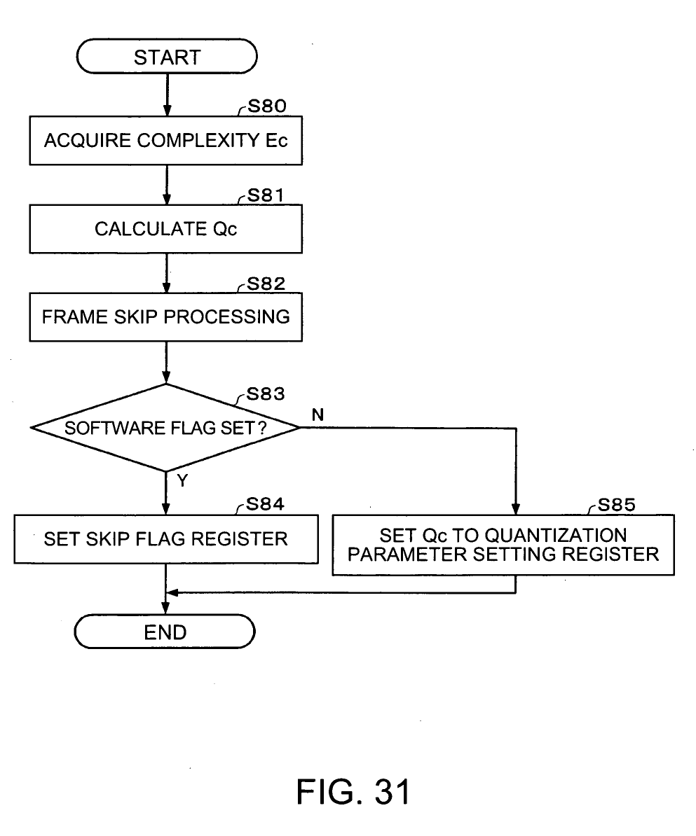

FIG. 31 illustrates one example of a flow chart of ME interrupt processing. The memory 214 stores a program for realizing the processing shown in FIG. 31. The CPU 212 reads in the program to realize the processing shown in FIG. 31.

The ME interrupt processing is implemented in the step S74 of FIG. 28.

When ME interrupt is detected, the CPU 212 reads out the complexity Ec generated at the motion estimator 114 via the host I/F 202 (step S80). The complexity Ec is generated at the motion estimator 114 in accordance with the formula shown in FIG. 6.

Subsequently, the CPU 212 determines the quantization parameter Qc (step S81). Specifically, the CPU 212 determines the quantization parameter Qc as described referring to FIGS. 16 through 20.

Next, the CPU 212 implements frame skip processing (step S82). The frame skip processing is any of processing shown in FIGS. 22, 23 and 24. The frame skip setting (steps S114, S122 and S132) in each processing is processing only for setting the software flag in the sense that a determination to skip the current frame is made.

Thereafter, if the software flag is set as a result of the frame skip processing (step S83: Y), the CPU 212 sets the skip flag register 132 via the host I/F 202 (step 84). If the software flag is not set (step S83: N), the quantization parameter Qc determined in the step S81 is set in the quantization parameter setting register 206 via the host I/F 202 (step S85).

Subsequently to the step S84 or S85, the sequence of the processing is completed (end).

Referring back to FIG. 26, a further description will be made. In the encoding IC 200, when the skip flag register 132 is set, the motion estimator 114 is initialized and the generation of image data of the current frame is skipped.

Meanwhile, the encoding IC 200 starts processing at the DCT unit 112 in response to the setting of the quantization parameter Qc to the quantization parameter setting register 206. Then, as described above, the quantizer 20 quantizes DCT coefficients (image data in the broad sense) generated by the DCT unit 112 with using the quantization parameter set in the quantization parameter setting register 206 and the quantization step values in a quantization table (not shown). The resulting quantized data is written to the FIFO buffer 30.

At this time, the FIFO access unit 34 increments and updates the count data every time the writing to the FIFO buffer 30 is carried out within the frame. Then, when the writing of quantized data to the FIFO buffer 30 has been completed, the FIFO unit 208 informs the host 210 of an encoding completion interrupt indicating the completion of encoding of one frame via the host I/F 202.

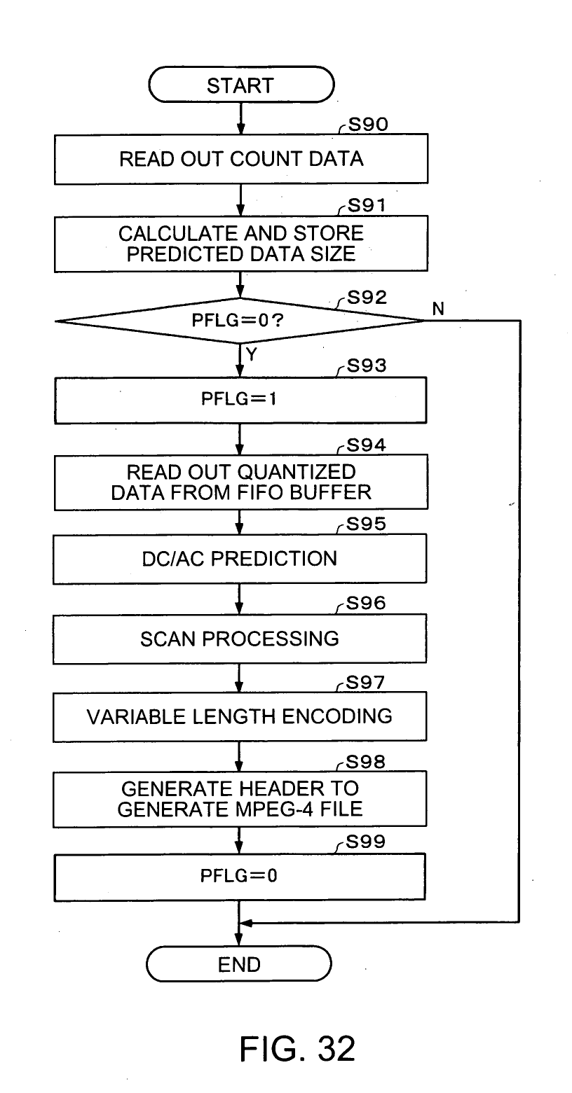

FIG. 32 illustrates one example of a flow chart of encoding completion interrupt processing. The memory 214 stores a program for realizing the processing shown in FIG. 32. The CPU 212 reads in the program to realize the processing shown in FIG. 32.

The encoding completion interrupt processing is implemented in the step S76 of FIG. 28.

When the CPU 212 detects an encoding completion interrupt, the CPU 212 reads out count data held in the count register 32 (step S90). Subsequently, as shown in FIG. 19, predicted data size y₀ is determined with using the count data read in the step S90 as x₀ so as to be stored in a certain temporary region (step S91).

Next, whether or not a processing execution flag PFLG is 0 is determined (step S92). The processing execution flag PFLG is a flag indicating whether or not the generation processing (processing of steps S7 through S9 in FIG. 1A) of encoded data is in execution. If a determination is made that the processing execution flag PFLG is not 0 (step S92: N), a determination is made that the processing by the encoded data generator 40 is in execution, completing the sequence of the processing (end).

If a determination is made that the processing execution flag PFLG is 0 in the step S92 (step S92: Y), the generation of encoded data is executed.

In the generation of encoded data, the processing execution flag PFLG is set to 1, first (step S93). Thus, even if an encoding completion interrupt is generated during the generation processing, the encoded data generator 40 can be kept waiting to execute the generation of encoded data of the next frame.

Subsequently, quantized data of one frame is read out from the FIFO buffer 30 by a unit of certain bytes (step S94).

Then, the CPU 212 implements DC/AC prediction processing (step S95), scan processing (step S96) and variable length encoding processing (step S97) for each macroblock, so as to generate encoded data.

Next, the CPU 212 adds macroblock header to encoded data generated in the step S97. The generation of encoded data thus obtained is carried out for one video object plane (VOP), while GOV header and VOP header are generated based on the quantization parameter that has been determined. When encoding for a predetermined number of frames is completed, the encoded data is output as an MPEG-4 file (step S98).

Subsequently to the step S98, the processing execution flag PFLG is set to 0 (step S99), and then the sequence of the processing is completed (end).

As described above, the compression processing of image data is implemented with making the hardware processor 110 and the software processor 150 share the processing.

In order to implement the above-described rate control by the encoding IC 200, the host 210 stores the following processing formula for linear transformation to achieve the rate control in the present embodiment.

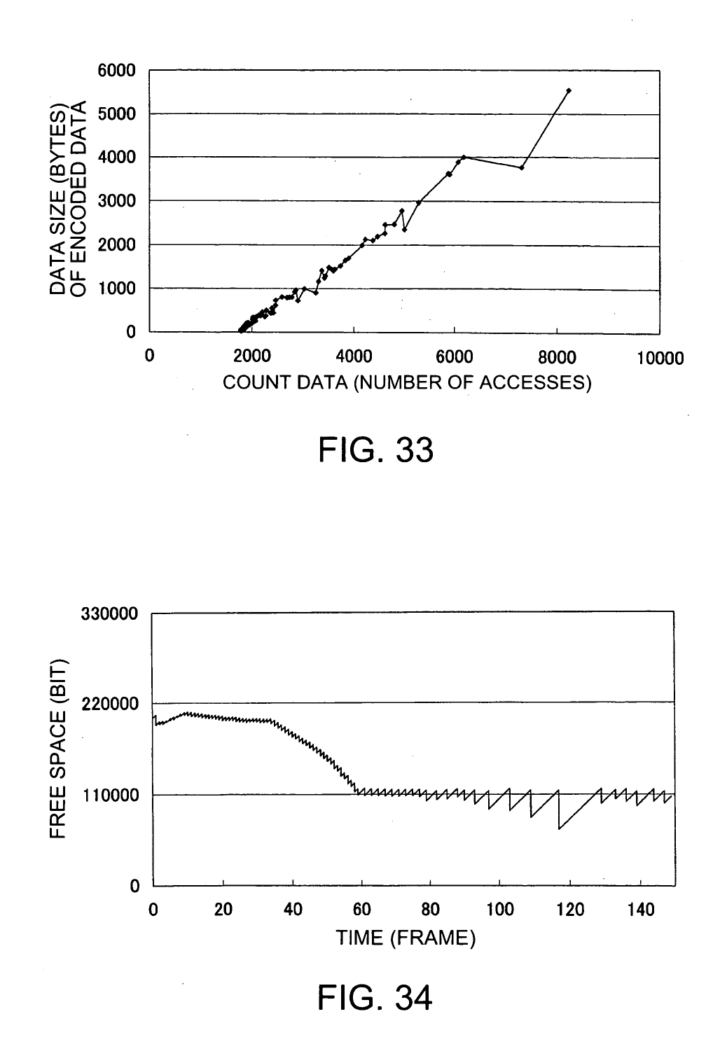

FIG. 33 is a diagram showing the relationship between count data and predicted data size.

Here, it is assumed that a bit rate is 64 kilobits per second (bps), a frame rate is 15 frames per second (fps) and image size is QCIF (176×144 pixels). The horizontal axis shows count data indicating the number of accesses to the FIFO buffer 30, while the vertical axis shows the actual measurement of the data size (the number of bytes) of encoded data after VLC encoded.

As the drawing shows, count data and the data size of encoded data have a linear relationship.

The linear relationship shown in FIG. 33 can be approximately expressed by assigning, for example, ⅘ to a and (13.5625×99×8) to b in equation (1) based on the actual measurement show in FIG. 33. Therefore, predicted data size can easily be determined by using the linear transformation formula.

FIG. 34 is a diagram explaining the advantageous effects of the image data compression device according to the present embodiment. FIG. 34 shows a simulation result explaining one example of the changes of free space on a VBV buffer provided in the image data compression device of the present embodiment. In FIG. 34, the horizontal axis shows the number of frames and the vertical axis shows the number of bits of free space on the VBV buffer.

In order to generate encoded data without the overflow or underflow at the VBV buffer, frame skip is carried out if the free space on the VBV buffer falls below a certain threshold (about 110000 bits). The diagram shows that the free space decreases when a frame is encoded. Also, the diagram shows that the free space increases when a encoding result is not output to the VBV buffer. In that manner, encoded data is generated so that certain amount of free space is maintained, thereby achieving a certain rate.

In FIG. 34, it is assumed that the number of all frames is 150, a bit rate is 64 kilobits per second (kbps), a frame rate is 15 frames per second (fps), VBV buffer size is 327680 bits, the threshold is 109226 bits, and the average data size of encoded data of past four frames is used in a comparative example. FIG. 34 shows a simulation result of encoding, under the above conditions, image data of moving images whose motion is small initially and becomes larger gradually.

In FIG. 34, when focusing attention on the change around 109226 bits, which is threshold, it is apparent that the free space is maintained near the threshold. This means that the prediction accuracy for predicted data size is high. That is, this means that the accuracy is high in determining predicted data size by linearly transforming the number of writing to the FIFO buffer 30 for the previous frame, and means that the accuracy of controlling a bit rate based on the predicted data size is high. Therefore, it is apparent that the present embodiment has the lower possibility of causing the overflow from the VBV buffer compared with the comparative example.

4. Display Controller

The function of the encoding IC in the present embodiment is applicable to a display controller.

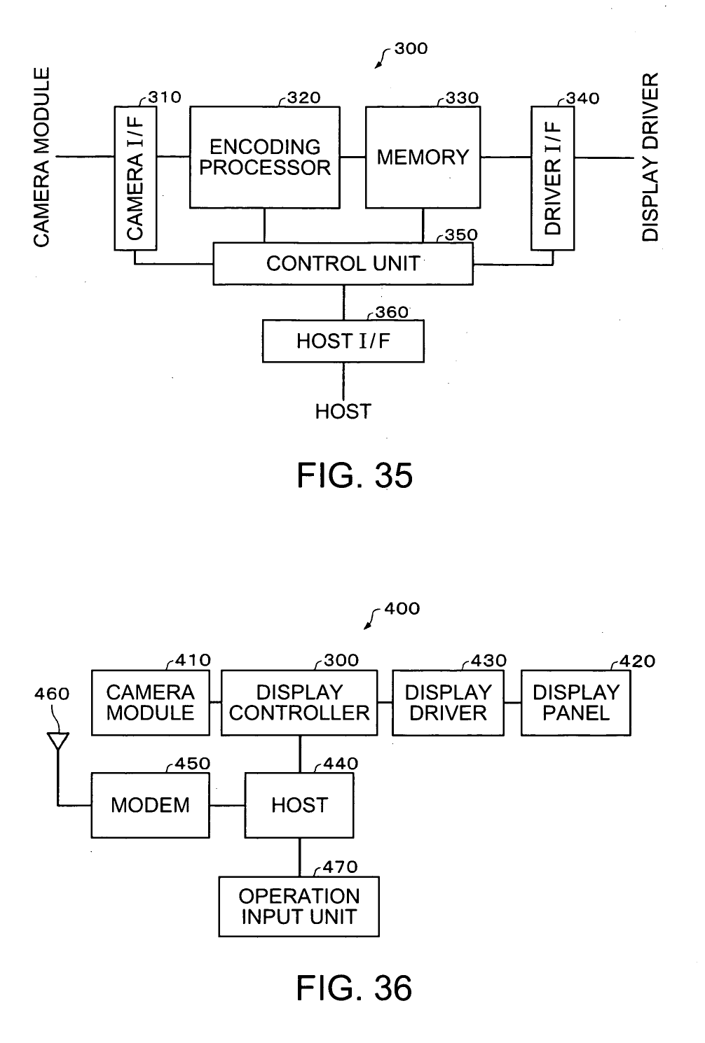

FIG. 35 shows a block diagram of a configuration example of a display controller according to the present embodiment.

A display controller 300 includes a camera I/F 310, an encoding processor 320, a memory 330, a driver I/F 340, a control unit 350 and a host I/F 360.

The camera I/F 310 is coupled to a camera module (not shown). The camera module has the configuration shown in FIG. 9, for example. The camera module outputs input image data of moving images obtained through imaging in YUV format, while outputs synchronization signals (for example, VSYNC signal) specifying the separation of one frame. The camera I/F 310 implements interface processing for receiving input image data of moving images generated at the camera module.

The encoding processor 320 corresponds to the encoding IC 200 of FIG. 26 from which the functions of the host I/F 202 and the camera I/F 204 are eliminated. That is, the encoding processor 320 has the functions of the quantizer 20, the FIFO unit 208, the DCT unit 112, the motion estimator 114, the inverse quantizer 116, the inverse DCT unit 118, the motion compensator 120, the quantization parameter setting register 206, the software starting flag register 130 and the skip flag register 132, shown in FIG. 26.

The memory 330 stores encoded data output from the encoding processor 320. The memory 330 stores image data for displaying images on a display panel. The driver I/F 340 reads out image data from the memory 330 periodically so as to supply the image data to a display driver for driving the display panel. The driver I/F 340 implements interface processing for sending image data to the display driver.

The control unit 350 controls the camera I/F 310, the encoding processor 320, the memory 330 and the driver I/F 340. The control unit 350 implements, in accordance with the indication from a host (not shown) via the host I/F 360 for example, the processing of receiving input image data from a camera module, encoding the input image, writing encoded data to the memory 330, reading out image data for displaying from the memory 330, and sending the image data to a display driver.

FIG. 36 illustrates a block diagram of a configuration example of electronic apparatuses to which the display controller shown in FIG. 35 is applied. Here, a block diagram of a configuration example of a cellular phone as one of the electronic apparatuses is shown. The same parts as those of FIG. 35 are given the same numerals and the explanation thereof will appropriately be omitted.

A cellular phone 400 includes a camera module 410. The camera module 410 has a CCD camera to supply the data of images captured by the CCD camera to the display controller 300 in YUV format.

The cellular phone 400 includes a display panel 420. A liquid crystal display panel can be used as the display panel 420. In this case, the display panel 420 is driven by a display driver 430. The display panel 420 includes a plurality of scanning lines, a plurality of data lines and a plurality of pixels. The display driver 430 has the function of a scanning driver for selecting scanning lines by a unit of one or plural scanning lines, while has the function of a data driver for supplying a voltage corresponding to image data to the plural data lines.

The display controller 300 is coupled to the display driver 430 and supplies image data to the display driver 430.

A host 440 is coupled to the display controller 300. The host 440 controls the display controller 300. Also, the host 440 can demodulate image data received via an antenna 460 at a modem 450, and then can supply the image data to the display controller 300. The display controller 300 displays images on the display panel 420 by the display driver 430 based on the image data.

The host 440 has the same function as that of the host 210 in FIG. 26. The host 440 can encode at the encoding processor 320 image data generated by the camera module 410 and modulate the image data at the modem 450, and then can indicate the sending of the image data to another communication apparatus via the antenna 460. At this time, the display controller 300 can encode image data generated at the camera module 410 and output to the host 440 encoded data obtained through the encoding.

The host 440 implements, based on operation information from an operation input unit 470, the processing of sending/receiving image data, encoding, imaging at the camera module 410 and displaying on the display panel.

The present invention is not limited to the example of FIG. 36 in which a liquid crystal display panel is used as the display panel 420. The display panel 420 may be an electro luminescence display or a plasma display device, and can be applied to a display controller supplying image data to a display driver for driving the display.

It should be noted that the present invention is not limited to the above-described embodiments, and can be modified within the scope of the present invention.

In the aspects according to the dependent claims of the present invention, part of elements may be omitted. Moreover, the essential part in one aspect according to one of the independent claims of the present invention may be included in another aspect according to another independent claim.

1. An image data compression device for compressing image data, comprising:
a decimation detector detecting whether or not an input frame is a frame to be decimated every time image data of one frame is input from an imaging unit;
a compression processor compressing the image data to generate encoded data at a certain rate; and
a frame skip unit implementing skip processing for skipping compression processing for image data of one frame by the compression processor, based on a detection result by the decimation detector, wherein the frame skip unit implements the skip processing on condition that the decimation detector has determined that the input frame is a frame to be decimated.

2. The image data compression device according to claim 1, wherein the decimation detector detects, of CA input frames of image data from the imaging unit, (CA-TA) frames of image data as a frame to be decimated, where CA is an input frame rate of image data from the imaging unit (CA is a positive integer) and TA is a generation rate of encoded data after the compression processing (CA>TA, TA is a positive integer).

3. The image data compression device according to claim 2, wherein:
the decimation detector compares a count value of a frame of image data input from the imaging unit with one value of at least one frame decimation interval that is decimal data determined as an integer multiple of CA/(CA-TA); and
the decimation detector detects the input frame as a frame to be decimated if the count value is equal to or more than the one value of the at least one frame decimation interval.

4. The image data compression device according to claim 3, wherein the frame decimation interval is determined prior to processing of the decimation detector on condition that an input frame rate of image data from the imaging unit has varied.

5. The image data compression device according to claim 1, wherein the compression processor includes a rate controller that varies data size after the compression processing for each frame to control a generation rate of data after the compression processing.

6. The image data compression device according to claim 5, wherein:
the compression processor includes:
a quantizer that quantizes the image data with a quantization step varying based on a quantization parameter;
a FIFO buffer to which quantized data of a plurality of frames quantized by the quantizer is buffered; and
an encoded data generator that reads out quantized data from the FIFO buffer asynchronously with writing to the FIFO buffer so as to generate encoded data by encoding the quantized data;
the rate controller determines, from data size of quantized data of a previous frame of a current frame, predicted data size of encoded data of the previous frame so as to determine the quantization parameter by using the predicted data size, the rate controller varying a quantization step of the quantizer for each frame based on the quantization parameter so as to control data size of encoded data; and
the frame skip unit implements the skip processing if frames having the quantization parameter larger than a skip threshold consecutively appear the number of times set as a consecutive skips threshold or more times.

7. The image data compression device according to claim 6, wherein the rate controller determines, by using the predicted data size, a quantization parameter that is equal to or less than a settable quantization parameter upper threshold.

8. The image data compression device according to claim 6, further comprising a count register holding count data corresponding to the number of accesses to the FIFO buffer, wherein the rate controller determines the predicted data size from the count data.

9. The image data compression device according to claim 6, wherein the predicted data size is determined by linearly transforming data size of quantized data of the previous frame.

10. The image data compression device according to claim 6, further comprising a quantization table storing a quantization step value, wherein the rate controller varies the quantization step by implementing quantization with using a product of the quantization parameter and the quantization step value.

11. The image data compression device according to claim 6, further comprising a discrete cosine transform unit supplying the image data that has been discrete cosine transformed to the quantizer in each frame.

12. The image data compression device according to claim 6, further comprising:
a hardware processor that processes image data of moving images by hardware; and
a software processor that encodes quantized data read out from the FIFO buffer by software to generate encoded data, wherein:
the hardware processor includes the quantizer and the FIFO buffer; and
the software processor includes the encoded data generator, the rate controller, the decimation detector and the frame skip unit.

13. The image data compression device according to claim 5, wherein:
the compression processor includes:
a quantizer that quantizes the image data with a quantization step varying based on a quantization parameter;
a FIFO buffer in which quantized data of a plurality of frames quantized by the quantizer is buffered; and
an encoded data generator that reads out quantized data from the FIFO buffer asynchronously with writing to the FIFO buffer so as to generate encoded data by encoding the quantized data;
the rate controller determines, from data size of quantized data of a previous frame of a current frame, predicted data size of encoded data of the previous frame so as to determine the quantization parameter by using the predicted data size, the rate controller varying a quantization step of the quantizer for each frame based on the quantization parameter so as to control data size of encoded data; and
the frame skip unit implements the skip processing if a complexity corresponding to a difference between image data to be quantized by the quantizer and image data of a previous frame of a frame of the image data to be quantized is equal to or more than a complexity threshold.

14. The image data compression device according to claim 13, wherein the rate controller determines, by using the predicted data size, a quantization parameter that is equal to or less than a settable quantization parameter upper threshold.

15. The image data compression device according to claim 13, further comprising a count register holding count data corresponding to the number of accesses to the FIFO buffer, wherein the rate controller determines the predicted data size from the count data.

16. The image data compression device according to claim 13, wherein the predicted data size is determined by linearly transforming data size of quantized data of the previous frame.

17. An electronic apparatus comprising the image data compression device according to claim 1.

18. An image data compression method for compressing image data, comprising:
detecting whether or not an input frame is a frame to be decimated every time image data of one frame is input from an imaging unit;
compressing image data of a frame that has been determined as a frame not to be decimated to generate encoded data at a certain rate; and
detecting, of CA input frames of image data from the imaging unit, (CA-TA) frames of image data as a frame to be decimated, where CA is an input frame rate of image data from the imaging unit (CA is a positive integer), and TA is a generation rate of encoded data after the compression processing (CA>TA, TA is a positive integer).

19. The image data compression method according to claim 18, wherein data size after the compression processing is varied for each frame to control a generation rate of data after the compression processing.

20. The image data compression method according to claim 18, wherein:
a count value of a frame of image data input from the imaging unit is compared with one value of at least one frame decimation interval that is decimal data determined as an integer multiple of CA/(CA-TA); and
the input frame is detected as a frame to be decimated if the count value is equal to or more than the one value of the at least one frame decimation interval.
